(19) United States
(12) Patent Application Publication
(10) Pub. No.: US 2010/0218012 A1
(43) Pub. Date: Aug. 26, 2010

(54) METHODS AND SYSTEMS FOR PROVIDING A WIRELESS SECURITY SERVICE AND/OR A WIRELESS TECHNICAL SUPPORT SERVICE FOR PERSONAL COMPUTERS

(76) Inventors: Johnson Joseph, Montreal (CA); Varujan Tasci, Dollard Des Ormeaux (CA); Laval Bolduc, Longueuil (CA)

Correspondence Address: HOLLAND & KNIGHT LLP, 10 ST. JAMES AVENUE, BOSTON, MA, 02116-3889, US

(21) Appl. No.: 12/665,512

(22) PCT Filed: May 26, 2008
(86) PCT No.: PCT/CA08/00997

§ 371 Date: Dec. 18, 2009

Related U.S. Application Data
(60) Provisional application No. 60/944,673, filed on Jun. 18, 2007.
(60) Provisional application No. 61/036,778, filed on Mar. 14, 2008.

(51) Int. Cl. G06F 1/26; G06F 15/00; G06F 11/00; G06F 17/00; G06F 21/00; G06F 9/44

(52) U.S. Cl. 713/310; 726/34; 726/26

(57) ABSTRACT

Methods and systems for providing a wireless security service and/or a wireless technical support service for a personal computer. The personal computer comprises a control unit for processing information conveyed by signals transmitted over a wireless network and received by a wireless interface of the personal computer. By processing this information, the control unit may: send at least one command for execution by a power management controller of the personal computer such that, upon executing the at least one command, the power management controller changes a power state of the personal computer (e.g., powers off the personal computer and prevents the personal computer from being powered on, or powers on the personal computer); cause booting software to become corrupted; cause various technical support operations (diagnostics and/or maintenance operations) to be performed on the personal computer; and/or cause the wireless interface to transmit over the wireless network information regarding a boot sequence of the personal computer.

### CROSS-REFERENCE TO RELATED APPLICATIONS

This application claims priority from U.S. Provisional Patent Application No. 60/944,673 filed on Jun. 18, 2007 by Johnson Joseph et al. and hereby incorporated by reference herein and from U.S. Provisional Patent Application No. 61/036,778 filed on Mar. 14, 2008 by Johnson Joseph et al. and hereby incorporated by reference herein.

### FIELD OF THE INVENTION

The invention relates generally to personal computers and, more particularly, to methods and systems for providing a wireless security service and/or a wireless technical support service for personal computers.

### BACKGROUND

Portable computers such as laptop computers are convenient and efficient tools widely employed by professionals, students and other individuals. Unfortunately, owing to their size, portability and resale value, laptop computers are prone to being stolen, lost or otherwise compromised. In particular, theft of laptop computers has become an alarming problem in various areas. In addition to loss of physical property, a stolen or lost laptop computer often results in loss of and/or unauthorized access to important information stored therein (e.g., confidential or sensitive information, work documents, etc.).

While techniques have been devised to attempt to recover stolen or lost laptop computers, they are unsatisfactory and often easily defeated. For example, some techniques require a stolen or lost laptop computer to be connected to a public data network (e.g.; the Internet) or phone line in order to identify its location. This is obviously useless when the stolen or lost laptop computer is not so connected. Moreover, these techniques rely on software installed in the stolen or lost laptop computer and managed by the laptop computer's operating system (OS). In case of theft, this software can thus be uninstalled or otherwise disabled.

In addition, technical support services for laptop computers may often be unsatisfactory. For example, a user of a laptop computer on a business or other trip may be at a location where in-person technical support is impractical or impossible. While certain remote technical support services exist, they typically consist of phone conversations with a remote technician and/or require a connection to a public data network (e.g., the Internet) in order to try to identify and solve problems, and are thus of limited effectiveness. Moreover, existing remote technical support services normally require involvement of a laptop computer's user, not only to initiate the required data network connection but also to interact with the remote technician.

Although such theft/loss or technical support issues often arise with portable computers, similar issues can arise with other types of personal computers, including desktop computers.

Accordingly, there is a need for enhancing security of personal computers and facilitating recovery of stolen, lost or otherwise missing personal computers. There is also a need for facilitating remote technical support for users of personal computers.

### SUMMARY OF THE INVENTION

According to a first broad aspect, the invention provides a personal computer comprising: a main processing unit comprising at least one processor for executing software implementing an operating system; a power management controller for controlling a power supply; a wireless interface for receiving a wireless signal over a wireless network, the wireless signal conveying information indicative that the personal computer is to be powered off; and a control unit comprising at least one processor for processing the information to send at least one command for execution by the power management controller such that, upon executing the at least one command, the power management controller powers off the personal computer and prevents the personal computer from being powered on.

According to a second broad aspect, the invention provides an apparatus for a personal computer, the personal computer comprising: a main processing unit comprising at least one processor for executing software implementing an operating system; a power management controller for controlling a power supply; and a wireless interface for receiving wireless signals over a wireless network. The apparatus comprises: an input for receiving information indicative that the personal computer is to be powered off, the information being conveyed by a wireless signal received by the wireless interface; a processing element comprising at least one processor for processing the information to generate at least one command for execution by the power management controller such that, upon executing the at least one command, the power management controller powers off the personal computer and prevents the personal computer from being powered on; and an output for sending the at least one command to the power management controller.

According to a third broad aspect, the invention provides an apparatus for communicating with a personal computer at a remote location via a wireless network, the personal computer comprising: a main processing unit comprising at least one processor for executing software implementing an operating system; a power management controller for controlling a power supply; and a wireless interface for receiving wireless signals over a wireless network. The apparatus comprises: an interface for sending messages to the personal computer via the wireless network; and a processing unit comprising at least one processor for: (i) generating at least one message to cause the power management controller to execute at least one command to power off the personal computer and prevent the personal computer from being powered on; and (ii) causing the interface to send the at least one message to the personal computer via the wireless network.

According to a fourth broad aspect, the invention provides a method for communicating with a personal computer at a remote location via a wireless network, the personal computer comprising: a main processing unit comprising at least one processor for executing software implementing an operating system; a power management controller for controlling a power supply; and a wireless interface for receiving wireless signals over a wireless network. The method comprises: generating at least one message to cause the power management controller to execute at least one command to power off the personal computer and prevent the personal computer from being powered on; and sending the at least one message to the personal computer via the wireless network.

According to a fifth broad aspect, the invention provides a personal computer comprising: a main processing unit comprising at least one processor for executing software implementing an operating system; a power management controller for controlling a power supply; a wireless interface for receiving a wireless signal over a wireless network, the wireless signal conveying information indicative that the personal computer is to be powered on; and a control unit comprising at least one processor for processing the information to send at least one command for execution by the power management controller such that, upon executing the at least one command, the power management controller powers on the personal computer.

According to a sixth broad aspect, the invention provides an apparatus for a personal computer, the personal computer comprising: a main processing unit comprising at least one processor for executing software implementing an operating system; a power management controller for controlling a power supply; and a wireless interface for receiving wireless signals over a wireless network. The apparatus comprises: an input for receiving information indicative that the personal computer is to be powered on, the information being conveyed by a wireless signal received by the wireless interface; a processing element comprising at least one processor for processing the information to generate at least one command for execution by the power management controller such that, upon executing the at least one command, the power management controller powers on the personal computer; and an output for sending the at least one command to the power management controller.

According to a seventh broad aspect, the invention provides an apparatus for communicating with a personal computer at a remote location via a wireless network, the personal computer comprising: a main processing unit comprising at least one processor for executing software implementing an operating system; a power management controller for controlling a power supply; and a wireless interface for receiving wireless signals over a wireless network. The apparatus comprises: an interface for sending messages to the personal computer via the wireless network; and a processing unit comprising at least one processor for: (i) generating at least one message to cause the power management controller to execute at least one command to power on the personal computer; and (ii) causing the interface to send the at least one message to the personal computer via the wireless network.

According to an eighth broad aspect, the invention provides a method for communicating with a personal computer at a remote location via a wireless network, the personal computer comprising: a main processing unit comprising at least one processor for executing software implementing an operating system; a power management controller for controlling a power supply; and a wireless interface for receiving wireless signals over a wireless network. The method comprises: generating at least one message to cause the power management controller to execute at least one command to power on the personal computer; and sending the at least one message to the personal computer via the wireless network.

According to a ninth broad aspect, the invention provides a personal computer comprising: a main processing unit comprising at least one processor for executing software implementing an operating system; a power management controller for controlling a power supply; a wireless interface for receiving a wireless signal over a wireless network, the wireless signal conveying information indicative of a desired change to be made to a power state of the personal computer; and a control unit comprising at least one processor for processing the information to send at least one command for execution by the power management controller such that, upon executing the at least one command, the power management controller changes the power state of the portable computer in accordance with the desired change.

According to a tenth broad aspect, the invention provides an apparatus for a personal computer, the personal computer comprising: a main processing unit comprising at least one processor for executing software implementing an operating system; a power management controller for controlling a power supply; and a wireless interface for receiving wireless signals over a wireless network. The apparatus comprises: an input for receiving information indicative of a desired change to be made to a power state of the personal computer, the information being conveyed by a wireless signal received by the wireless interface; a processing element comprising at least one processor for processing the information to generate at least one command for execution by the power management controller such that, upon executing the at least one command, the power management controller changes the power state of the portable computer in accordance with the desired change; and an output for sending the at least one command to the power management controller.

According to an eleventh broad aspect, the invention provides an apparatus for communicating with a personal computer at a remote location via a wireless network, the personal computer comprising: a main processing unit comprising at least one processor for executing software implementing an operating system; a power management controller for controlling a power supply; and a wireless interface for receiving wireless signals over a wireless network. The apparatus comprises: an interface for: (i) sending messages to the personal computer via the wireless network; and (ii) receiving information indicative of a desired change to be made to a power state of the personal computer; and a processing unit comprising at least one processor for: (i) generating at least one message to cause the power management controller to execute at least one command to change the power state of the personal computer in accordance with the desired change; and (ii) causing the interface to send the at least one message to the personal computer via the wireless network.

According to a twelfth broad aspect, the invention provides a method for communicating with a personal computer at a remote location via a wireless network, the personal computer comprising: a main processing unit comprising at least one processor for executing software implementing an operating system; a power management controller for controlling a power supply; and a wireless interface for receiving wireless signals over a wireless network. The method comprises: receiving information indicative of a desired change to be made to a power state of the personal computer; generating at least one message to cause the power management controller to execute at least one command to change the power state of the personal computer in accordance with the desired change; and sending the at least one message to the personal computer via the wireless network.

According to a thirteenth broad aspect, the invention provides a personal computer comprising: a main processing unit comprising at least one processor for executing: (i) first software implementing an operating system; and (ii) second software implementing a booting operation to initiate loading of the operating system; a wireless interface for wirelessly receiving a signal over a wireless network, the signal conveying information indicative that the personal computer is to be prevented from booting; and a control unit comprising at least one processor for processing the information to cause the second software implementing the booting operation to become corrupted.

According to a fourteenth broad aspect, the invention provides an apparatus for a personal computer, the personal computer comprising: a main processing unit comprising at least one processor for executing first software implementing an operating system and second software implementing a booting operation to initiate loading of the operating system; and a wireless interface for wirelessly receiving signals over a wireless network. The apparatus comprises: an input for receiving information indicative that the personal computer is to be prevented from booting, the information being conveyed by a signal wirelessly received by the wireless interface; and a processing element comprising at least one processor for processing the information to cause the second software implementing the booting operation to become corrupted.

According to a fifteenth broad aspect, the invention provides an apparatus for communicating with a personal computer at a remote location via a wireless network, the personal computer comprising: a main processing unit comprising at least one processor for executing first software implementing an operating system and second software implementing a booting operation to initiate loading of the operating system; and a wireless interface for wirelessly receiving signals over a wireless network. The apparatus comprises: an interface for sending messages to the personal computer via the wireless network; and a processing unit comprising at least one processor for: (i) generating at least one message to cause the second software implementing the booting operation to become corrupted; and (ii) causing the interface to send the at least one message to the personal computer via the wireless network.

According to a sixteenth broad aspect, the invention provides a method for communicating with a personal computer at a remote location via a wireless network, the personal computer comprising: a main processing unit comprising at least one processor for executing first software implementing an operating system and second software implementing a booting operation to initiate loading of the operating system; and a wireless interface for wirelessly receiving signals over a wireless network. The method comprises: generating at least one message to cause the second software implementing the booting operation to become corrupted; and sending the at least one message to the personal computer via the wireless network.

According to a seventeenth broad aspect, the invention provides a personal computer comprising: a main processing unit comprising at least one processor for executing: (i) first software implementing an operating system; and (ii) second software implementing a booting sequence to initiate loading of the operating system; a wireless interface for wirelessly receiving and sending messages over a wireless network; and a control unit comprising at least one processor for: (i) monitoring the booting sequence to obtain information regarding the boot sequence; and (ii) causing the wireless interface to wirelessly send the information regarding the boot sequence over the wireless network.

According to an eighteenth broad aspect, the invention provides an apparatus for a personal computer, the personal computer comprising: a main processing unit comprising at least one processor for executing first software implementing an operating system and second software implementing a booting sequence to initiate loading of the operating system; and a wireless interface for wirelessly receiving and sending messages over a wireless network. The apparatus comprises: a processing element comprising at least one processor for: (i) monitoring the booting sequence to obtain information regarding the boot sequence; and (ii) generating at least one message conveying the information regarding the boot sequence; an output for releasing the at least one message to the wireless interface to cause the wireless interface to wirelessly send the at least one message over the wireless network.

According to a nineteenth broad aspect, the invention provides an apparatus for communicating with a personal computer at a remote location via a wireless network, the personal computer comprising: a main processing unit comprising at least one processor for executing first software implementing an operating system and second software implementing a booting sequence to initiate loading of the operating system; and a wireless interface for wirelessly receiving and sending messages over a wireless network. The apparatus comprises: an interface for exchanging messages with the personal computer via the wireless network; and a processing unit comprising at least one processor for: (i) generating a first message instructing the personal computer to send a second message conveying information regarding the booting sequence via the wireless network; (ii) causing the interface to send the first message to the personal computer via the wireless network; (iii) processing the second message when received by the interface to obtain the information regarding the boot sequence.

According to a twentieth broad aspect, the invention provides a method for communicating with a personal computer at a remote location via a wireless network, the personal computer comprising: a main processing unit comprising at least one processor for executing first software implementing an operating system and second software implementing a booting sequence to initiate loading of the operating system; and a wireless interface for wirelessly receiving and sending messages over a wireless network. The method comprises: generating a first message instructing the personal computer to send a second message conveying information regarding the booting sequence via the wireless network; sending the first message to the personal computer via the wireless network; processing the second message when received to obtain the information regarding the boot sequence.

According to a twenty-first broad aspect, the invention provides a personal computer, comprising: a display for displaying information to a user; a keyboard for receiving input from the user; a main processing unit comprising at least one processor for executing software, the software implementing: (i) an operating system; (ii) a boot operation to initiate loading of the operating system; a diagnostics unit to allow a technician at a remote location to perform diagnostics and/or maintenance on the personal computer, the diagnostics unit including: (i) a wireless interface including an RF receiver to receive a wireless signal conveying diagnostics and/or maintenance commands from the remote location for execution by the personal computer, the diagnostics unit capable of implementing a plurality of levels of access control over diagnostics and/or maintenance commands sent to the personal computer via the wireless interface; and (ii) a user operable selector enabling the user to select a level of access control among the plurality of levels of access control to be implemented by the diagnostics unit.

According to a twenty-second broad aspect, the invention provides a method for activating a wireless security service for a personal computer, the personal computer comprising a security unit for transmitting information indicative of a location of the personal computer to a remote security entity via a wireless network, the security unit being in an inactive state in which the wireless network precludes transmission of the information indicative of the location of the portable computer to the remote security entity. The method comprises: receiving a request to activate the wireless security service; and providing activation information to be transmitted by the personal computer to a wireless network entity via the wireless network to cause the wireless network to allow transmission of the information indicative of the location of the personal computer to the remote security entity.

According to a twenty-third broad aspect, the invention provides an apparatus for activating a wireless security service for a personal computer, the personal computer comprising a security unit for transmitting information indicative of a location of the personal computer to a remote security entity via a wireless network, the security unit being in an inactive state in which the wireless network precludes transmission of the information indicative of the location of the personal computer to the remote security entity. The apparatus comprises: an interface for receiving a request to activate the wireless security service; and a processing unit for providing activation information to be transmitted by the personal computer to a wireless network entity via the wireless network to cause the wireless network to allow transmission of the information indicative of the location of the personal computer to the remote security entity.

According to a twenty-fourth broad aspect, the invention provides a method for activating a wireless security service for a personal computer, the personal computer comprising a security unit for transmitting information indicative of a location of the personal computer to a remote security entity via a wireless network, the security unit being in an inactive state in which the wireless network precludes transmission of the information indicative of the location of the personal computer to the remote security entity. The method comprises: contacting a service provider providing the wireless security service; receiving activation information from the service provider; and using a user interface of the personal computer to command the security unit to transmit the activation information to a wireless network entity via the wireless network to cause the wireless network to allow transmission of the information indicative of the location of the personal computer to the remote security entity.

According to a twenty-fifth broad aspect, the invention provides a method for recovering a personal computer, the personal computer comprising a security unit for transmitting location information indicative of a location of the personal computer to a remote security entity via a wireless network, the location information being indicative of a latitude, a longitude and an altitude of the personal computer. The method comprises: receiving the location information via the wireless network; and attempting to recover the personal computer based on the latitude, the longitude and the altitude of the personal computer.

According to a twenty-sixth broad aspect, the invention provides method for recovering a personal computer, the personal computer comprising a security unit for transmitting location information indicative of a location of the personal computer to a remote security entity via a wireless network, the location information being indicative of an altitude of the personal computer. The method comprises: receiving the location information via the wireless network; and attempting to recover the personal computer based on the location information, wherein, if the personal computer is determined to be located in a multi-unit building, the attempting comprises determining a region of the multi-unit building in which the personal computer is potentially located on a basis of the altitude of the personal computer.

According to a twenty-seventh broad aspect, the invention provides a portable location device for facilitating recovery of a personal computer, the personal computer comprising a security unit for transmitting location information indicative of a location of the personal computer via a wireless network. The portable location device comprises: a user interface; a location unit for wirelessly receiving at least one signal and deriving a location of the portable location device based on the at least one signal; and a processing unit for obtaining the location of the personal computer and causing the user interface to present information indicative of the location of the portable location device relative to the location of the personal computer.

These and other aspects of the invention will become apparent to those of ordinary skill in the art upon review of the following description of embodiments of the invention in conjunction with the accompanying drawings.

### BRIEF DESCRIPTION OF THE DRAWINGS

A detailed description of embodiments of the invention is provided herein below, by way of example only, with reference to the accompanying drawings, in which:

FIG. 1 shows an architecture for providing a wireless security service and/or a wireless technical support service to a user of a personal computer, in accordance with an embodiment of the invention, wherein the personal computer comprises a security/diagnostics unit for communicating with a remote security/technical support entity via a wireless network;

FIG. 2 shows an embodiment of the personal computer, including an embodiment of the security/diagnostics unit;

FIG. 3 shows an embodiment in which a control unit of the security/diagnostics unit of the personal computer is connected to a power management controller of the personal computer via a system management bus of the personal computer;

FIGS. 4 and 5 show an example of interaction between the security/diagnostics unit of the personal computer and the security/technical support entity as part of the wireless security service;

FIG. 6 shows an example of interaction between the security/diagnostics unit of the personal computer and the security/technical support entity as part of the wireless technical support service;

FIG. 7 shows a flowchart illustrating an example of a process to manage power consumption of the security/diagnostics unit as part of the wireless technical support service;

FIG. 8 shows a flowchart illustrating an example of a process for performing a selection of a level of access control that the security/diagnostics unit is to implement as part of the wireless technical support service, in accordance with an embodiment of the invention;

FIG. 9 shows an embodiment of a user operable selector, which includes at least one physical key on the personal computer, to allow the user to select a level of access control that the security/diagnostics unit is to implement as part of the wireless technical support service;

FIG. 10 shows another embodiment of a user operable selector, which includes at least one virtual key displayed on a screen of the personal computer, to allow the user to select a level of access control that the security/diagnostics unit is to implement as part of the wireless technical support service;

FIG. 11 shows a flowchart illustrating an example of a process by which a selection of a level of access control is effected during a booting sequence of the personal computer;

FIG. 12 shows a flowchart illustrating an example of operations that can occur under step 1104 of FIG. 8;

FIG. 13 shows an example of a process by which the personal computer may be provided with the security/diagnostics unit; and

FIGS. 14 and 15 show an example of a process by which the user may register for and activate the wireless security service and/or the wireless technical support service.

It is to be expressly understood that the description and drawings are only for purposes of illustration of example embodiments of the invention and are an aid for understanding. They are not intended to be a definition of the limits of the invention.

### DETAILED DESCRIPTION OF EMBODIMENTS

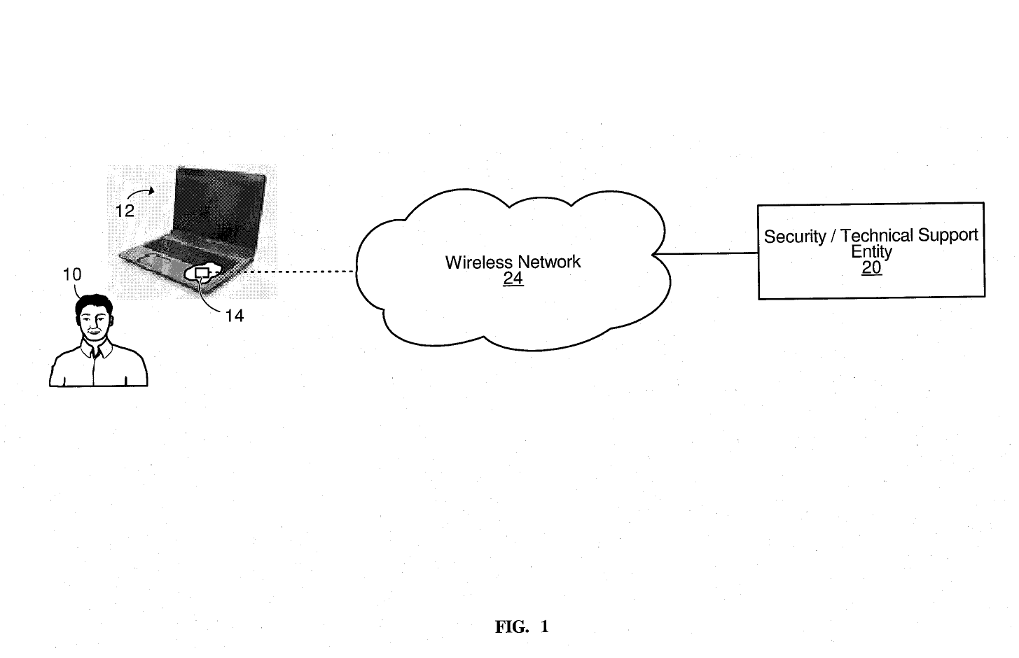

FIG. 1 shows an architecture for providing one or more wireless services to a user 10 of a laptop computer 12, in accordance with an embodiment of the invention. The laptop computer 12 can be any laptop computer, notebook computer, tablet personal computer (PC), or other similar portable computer. As further discussed below, one service that can be provided to the user 10 is a wireless security service that can be used in a situation where the user 10 realizes that the laptop computer 12 has been lost or stolen or is otherwise missing in order to attempt recovering the laptop computer 12. Another service that can be provided to the user 10 is a wireless technical support service that can be used in a situation where certain troubleshooting, software and/or hardware modifications, or other diagnostics and/or maintenance activities are to be remotely carried out on the laptop computer 12.

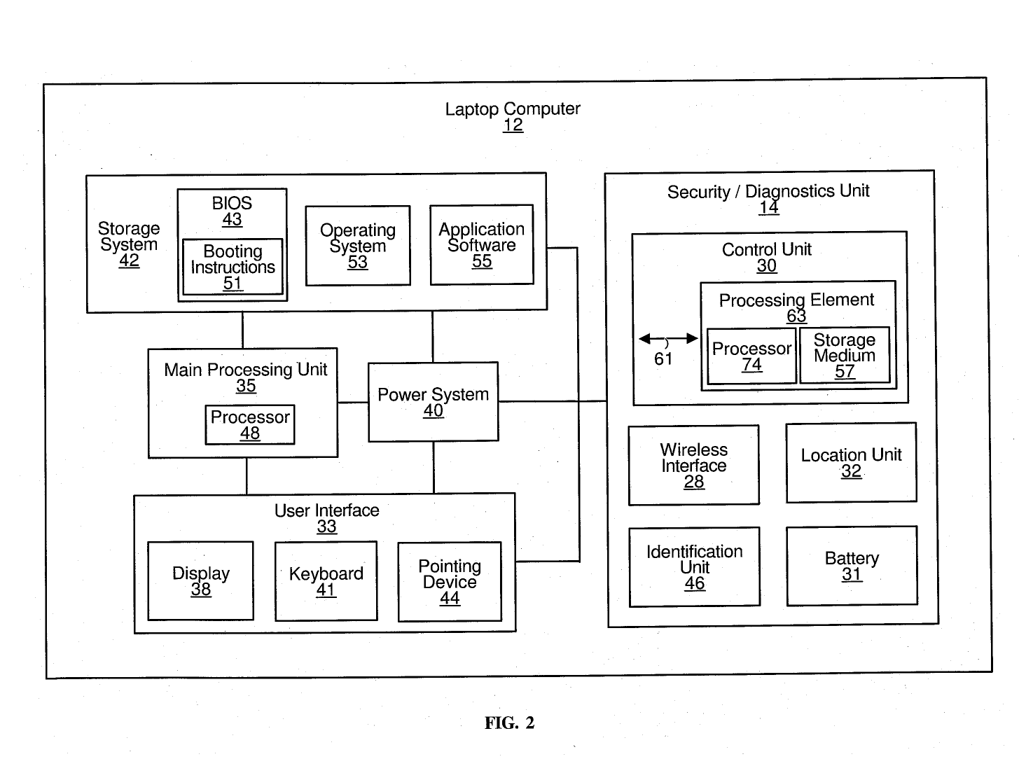

The laptop computer 12 comprises various hardware components and software (including firmware) components. For example, as shown in FIG. 2, the laptop computer 12 comprises a user interface 33 for allowing the user 10 to interact with the laptop computer 12 and a main processing unit 35 for executing software during operation of the laptop computer 12.

The user interface 33 comprises input and output devices for outputting information to the user 10 and receiving input from the user 10. More particularly, in this embodiment, the user interface 33 comprises a display 38 for displaying information to the user 10, a keyboard 41 for allowing the user 10 to input information or commands, and a pointing device 44 also for allowing the user 10 to input information or commands. The keyboard 41 may include an array of mechanical buttons. Alternatively, the keyboard 41 may be implemented as a virtual keyboard array, which, for example, can be displayed on the display 38 (or another display of the laptop computer 12) or projected onto a flat surface, whereby the user 10 can tap on virtual keys to provide input. The pointing device 44 may include a mouse, a pointing stick, a trackball, or a touch sensitive surface, such as a surface of the display 38 or a surface that is independent of the display 38. In other embodiments, the user interface 33 may comprise more or less than these components and/or other components (e.g., speakers, a microphone, a stylus, etc.).

The main processing unit 35 comprises one or more processors 48 for executing software during operation of the laptop computer 12. The software generally falls in three categories. The first category includes booting instructions 51 (e.g., a boot loader) to perform a boot operation. The second category includes an operating system (OS) 53 of the laptop computer 12. The third category includes application software 55 that is executed under control of the operating system 53.

The booting instructions 51 are implemented as program code that resides in memory of the laptop computer 12 that is accessed by the main processing unit 35 immediately after the laptop computer 12 is powered on. In this embodiment, the booting instructions 51 are part of a Basic Input/Output System (BIOS) 43 of the laptop computer 12 that is stored in read-only memory (ROM) (e.g., programmable read-only memory (PROM), erasable programmable read-only memory (EPROM), electrically erasable programmable read-only memory (EEPROM), flash memory).

The booting instructions 51 typically perform a power-on test (also called a “power-on self-test”) to determine if some or all of the hardware components of the laptop computer 12 function correctly. For example, the power on test may include: verifying operation of a random access memory (RAM) structure of the laptop computer 12; and access fundamental hardware components, such as the keyboard 41, hard disk controllers, video drivers, interface devices such as Universal Serial Bus (USB) devices, or network interface cards, in order to verify their operation and initialize them.

The booting instructions 51 may also examine a list of bootable devices, such as hard disks, to identify one that can be booted. A bootable device is one that can be read from and typically contains a boot sector. Execution of the boot sector usually loads a kernel of the operating system 53. At this point, the operating system 53 can execute commands, such as run the application software 55. Examples of operating systems include Windows™-based operating systems, operating systems commercialized by Apple Inc., or Linux-based operating systems. Examples of application software include word processors, spreadsheets, personal information managers (e.g., Outlook™) and media players.

Software executed by the main processing unit 35, including the booting instructions 51, the operating system 53 and the application software 55, is stored in a memory system 42 of the laptop computer 12. The memory system 42 comprises various types of storage devices (e.g., ROM, RAM, hard drives, etc.) for storing the software executed by the main processing unit 35.

The laptop computer 12 also comprises a power system 40 that controls whether the laptop computer 12 is powered on (activated) or powered off (deactivated). The power system 40 comprises a power supply, which may comprise circuitry for receiving power from a power outlet and a main battery to power the laptop computer 12 when it is not connected to a power outlet. The main battery may be connected to a charging circuit of the laptop computer 12 such that it can be recharged when the laptop computer 12 is powered from a power outlet.

In order to allow provision of the wireless security service and/or the wireless technical support service contemplated herein, the laptop computer 12 comprises a security/diagnostics unit 14 that is integrated into the laptop computer 12. By “integrated”, it is meant that the security/diagnostics unit 14 is internal to a casing of the laptop computer 12 and is an integral part of internal hardware of the laptop computer 12. For example, one or more components of the security/diagnostics unit 14 may be part of a motherboard or other circuit board of the laptop computer 12.

The security/diagnostics unit 14 is adapted to communicate with a network entity 20, hereinafter referred to as a “security/technical support entity”, at a remote location by sending and receiving messages via a wireless network 24. The wireless network 24 may be a cellular network or another wireless network covering a large geographical area of several hundred or several thousand square kilometers. Exchange of messages between the security/diagnostics unit 14 and the security/technical support entity 20 via the wireless network 24 may involve messages travelling on one or more wired communication links and/or traversing one or more other networks (e.g., the public switched telephone network (PSTN), the Internet, etc.) in addition to travelling over one or more wireless communication links of the wireless network 24.

The security/technical support entity 20 is operated by a service provider that provides the wireless security service and/or the wireless technical support service contemplated herein. In this embodiment, the security/technical support entity 20 is used to provide both the wireless security service and the wireless technical support service. In other embodiments, the security/technical support entity 20 may be used to provide only one of the wireless security service and the wireless technical support service, in which case another network entity similar to the security/technical support entity 20 may be used to provide the other one of the wireless security service and the wireless technical support service. Also, in this embodiment, the service provider operating the security/technical support entity 20 is distinct from a wireless network provider that provides access to the wireless network 24. In other embodiments, the service provider operating the security/technical support entity 20 may be the wireless network provider.

In addition to its wireless communication capability, the security/diagnostics unit 14 is adapted to interact with various hardware and software components of the laptop computer 12 for various purposes, as described later on. In this embodiment, the security/diagnostics unit 14 is also configured to operate independently of the operating system 53 of the laptop computer 12 (i.e., to operate without involving the operating system 53, in some cases even before the operating system 53 is loaded by the booting instructions 51).

By virtue of its capabilities to communicate with the security/technical support entity 20 and to interact with various hardware and software components of the laptop computer 12, the security/diagnostics unit 14 enables provision of the wireless security service and/or the wireless technical support service contemplated herein.

More particularly, as further discussed later on, in accordance with the wireless security service, in a situation where the user 10 realizes that the laptop computer 12 has been stolen or lost or is otherwise missing, the user 10 can contact the service provider operating the security/technical support entity 20 to report this situation. In response, the service provider may cause messages to be exchanged between the security/technical support entity 20 and the security/diagnostics unit 14 of the laptop computer 12 via the wireless network 24 in order to render the laptop computer 12 inoperative (e.g., by turning it off and preventing it from being turned on) and determine a location of the laptop computer 12 (e.g., an address and/or set of geo-coordinates where the laptop computer 12 is located). The location of the laptop computer 12, which can be tracked, may be communicated to police authorities to assist in recovery of the laptop computer 12. Upon recovery of the laptop computer 12 by the user 10, the service provider can proceed to cause the security/technical support entity 20 to exchange messages with the security/diagnostics unit 14 of the laptop computer 12 via the wireless network 24 in order to enable normal operation of the laptop computer 12 (e.g., turn it on and/or allow it to be turned on).

Also, in accordance with the wireless technical support service, in a situation where certain troubleshooting, software and/or hardware modifications, or other maintenance and/or diagnostic activities are to be remotely carried out on the laptop computer 12, the service provider operating the security/technical support entity 20 may, autonomously or in response to being contacted by the user 10 who may have reported a problem with the laptop computer 12, cause messages to be exchanged between the security/technical support entity 20 and the security/diagnostics unit 14 of the laptop computer 12 via the wireless network 24 in order to perform various technical support activities, such as: obtain from the laptop computer 12 information regarding various software components of the laptop computer 12, including its booting instructions 51, operating system 53 and other software components; obtain from the laptop computer 12 information regarding various hardware components of the laptop computer 12 (e.g., its hard drive, power supply, fan, etc.); upload information (e.g., drivers, applications, etc.) to the laptop computer 12; perform one or more tests to test functionality of various hardware and/or software components of the laptop computer 12; and/or other technical support activities. This can be convenient and efficient from the perspectives of both the user 10 and the service provider that can avoid unnecessary (and potentially costly) displacements to get a technician on site to physically repair, troubleshoot or otherwise modify the laptop computer 12. In cases where the service provider determines based on the exchange of messages between the security/technical support entity 20 and the security/diagnostics unit 14 of the laptop computer 12 that a physical modification of the laptop computer 12 needs to be effected (e.g., one or more hardware components need to be changed), the information derived from this exchange can pinpoint the required physical modification and allow a technician to make an on-site visit, or the user 10 to come to a service point, with materials (e.g., a replacement for the one or more defective hardware components) already prepared to rapidly effect the modification.

Before considering examples in which the wireless security service and the wireless technical support service can be used, an example embodiment of the security/diagnostics unit 14 will first be considered.

### Security/Diagnostics Unit

With reference to FIG. 2, there is shown an example embodiment of the security/diagnostics unit 14. The security/diagnostics unit 14 comprises suitable hardware and/or software that implement a plurality of functional components, including, in this embodiment, a wireless interface 28, a location unit 32, and a control unit 30.

The wireless interface 28 comprises a receiver such as a radio frequency (RF) receiver to receive signals over the wireless network 24. In this embodiment, the wireless interface 28 also comprises a transmitter such as a RF transmitter to transmit signals over the wireless network 24. The receiver and the transmitter of the wireless interface 28 may be separate components or implemented using one or more common components to form a transceiver.

In some embodiments, the wireless interface 28 may be dedicated to exchange of signals over the wireless network 24 for purposes of the wireless security service and/or the wireless technical support service contemplated herein. In other embodiments, the wireless interface 28 may not be dedicated to exchange of signals over the wireless network 24 for purposes of the wireless security service and/or the wireless technical support service, but may rather also be used to exchange signals over the wireless network 24 for other purposes. For example, in some embodiments, the wireless interface 28 may also be used for wirelessly accessing a data network such as the Internet, in which case the wireless interface 28 may be implemented as part of a wireless modem (e.g., a wireless broadband modem) of the laptop computer 12.

The location unit 32 is adapted to wirelessly receive one or more signals and determine a location of the laptop computer 12 based on these one or more signals. The location of the laptop computer 12 may be expressed as a set of geo-coordinates, including latitude, longitude and altitude coordinates. For example, the location unit 32 may be a global positioning system (GPS) receiver adapted to wirelessly receive signals from GPS satellites and determine the location of the laptop computer 12 based on these signals. In some embodiments, the location unit 32 may be configured to derive a civic location (e.g., detailed street address information) based on the one or more signals that it receives (e.g., by applying geo-coordinates to civic map knowledge to convert these geo-coordinates into a civic location).

In some embodiments, the location unit 32 may be omitted from the security/diagnostics unit 14. In such embodiments, the security/technical support entity 20 may be able to determine the location of the laptop computer 12 based on reception by three or more network elements (e.g., base stations) of a signal transmitted by the security/diagnostics unit 14 and on application of triangulation techniques.

The control unit 30 comprises suitable hardware and/or software for implementing an interface 61 and a processing element 63. The interface 61 implements one or more inputs and outputs via which the control unit 30 is connected to (i.e., directly or indirectly connected to) other components of the laptop computer 12, including, in this embodiment, the wireless interface 28, the location unit 32, the power system 40, the memory system 42, and the user interface 33.

The processing element 63 comprises one or more processors for performing processing operations to implement functionality of the control unit 30. A given one of these one or more processors may be a general-purpose processor having access to a storage medium (e.g., semiconductor memory, including one or more ROM and/or RAM memory devices) storing program code for execution by that processor to implement functionality of the control unit 30. Alternatively, a given one of these one or more processors may be a specific-purpose processor comprising one or more pre-programmed hardware or firmware elements (e.g., application-specific integrated circuits (ASICs), electrically erasable programmable read-only memories (EEPROMs), etc.) or other related elements to implement functionality of the control unit 30. In this embodiment, the processing element 63 comprises a processor 74 having access to a storage medium 57 storing program code for execution by the processor 74 to implement functionality of the control unit 30.

Upon reception by the wireless interface 28 of one or more messages transmitted by the security/technical support entity 20 and conveying command information indicative of certain operations to be performed by the laptop computer 12, the control unit 30 is operative to interact with one or more of the various components to which it is connected on a basis of the command information conveyed by these one or more messages. For example, as further described later on, the control unit 30 may send a control signal to the power system 40 to power off (deactivate) the laptop computer 12 if it is on (activated) and to prevent the laptop computer 12 from being powered on (activated) unless a subsequent control signal is sent by the control unit 30 to the power system 40 to allow the laptop computer 12 to be powered on. As another example, the control unit 30 may send a control signal to the memory system 42 to erase, encrypt or otherwise prevent access to data stored in one or more memory elements (e.g., a hard drive) of the memory system 42. As yet another example, the control unit 30 may send a control signal to a specific hardware component (e.g., a fan, a removable disk drive, etc.) to activate, deactivate, upload a software upgrade, or otherwise modify or test operation of that specific hardware component. Other interactions between the control unit 30 and the various components of the laptop computer 12 to which it is connected may take place based on messages transmitted by the security/technical support entity 20.

Also, the control unit 30 is adapted to generate messages for transmission by the wireless interface 28 to the security/technical support entity 20 via the wireless network 24. For example, autonomously or in response to a message transmitted by the security/technical support entity 20, the control unit 30 may interact with the location unit 32 to generate a message indicative of the location of the laptop computer 12 and cause the wireless interface 28 to transmit the generated message to the security/technical support entity 20 via the wireless network 24. As another example, the control unit 30 may generate and cause the wireless interface 28 to transmit to the security/technical support entity 20 via the wireless network 24 one or more messages indicative of a state of the security/diagnostics unit 14 (e.g., periodical “health check” messages) to ensure that it is operating correctly. As yet another example, the control unit 30 may generate and cause the wireless interface 28 to transmit to the security/technical support entity 20 via the wireless network 24 one or more messages acknowledging that certain actions have been performed by the control unit 30 (e.g., turn off the laptop computer 12 and prevent it from being turned on; erase, encrypt or otherwise prevent access to data stored in one or more memory elements of the laptop computer 12; etc.). As yet another example, the control unit 30 may generate and cause the wireless interface 28 to transmit to the security/technical support entity 20 via the wireless network 24 one or more messages conveying information regarding various software components of the laptop computer 12 (e.g., its booting instructions 51, operating system 53, etc.) and/or information regarding various hardware components of the laptop computer (e.g., a hard drive, power supply, fan, etc.).

In this embodiment, the control unit 30 is independent from the main processing unit 35 of the laptop computer 12 that implements the booting instructions 51, the operating system 53 and the application software 55 of the laptop computer 12. In particular, in some embodiments, the control unit 30 may be dedicated to provision of the wireless security service and/or the wireless technical support service contemplated herein. In that way, the control unit 30 can remain operative, and thus the wireless security service and/or the wireless technical support service can remain available, irrespective of operational status of the booting instructions 51, the operating system 53 and the application software 55 of the laptop computer 12 (i.e., even when some or all of these components are defective or inoperative).

The interface 61 of the control unit 30 allows the security/diagnostics unit 14 to interact with other components of the laptop computer 12. Many different ways exist to interface the security/diagnostics unit 14 with other components of the laptop computer 12. For example, in some embodiments, the security/diagnostics unit 14 may be mounted on a motherboard or other main circuit board of the laptop computer 12 such that it communicates with data paths on the motherboard or other main circuit board. Other possibilities exist in other embodiments.

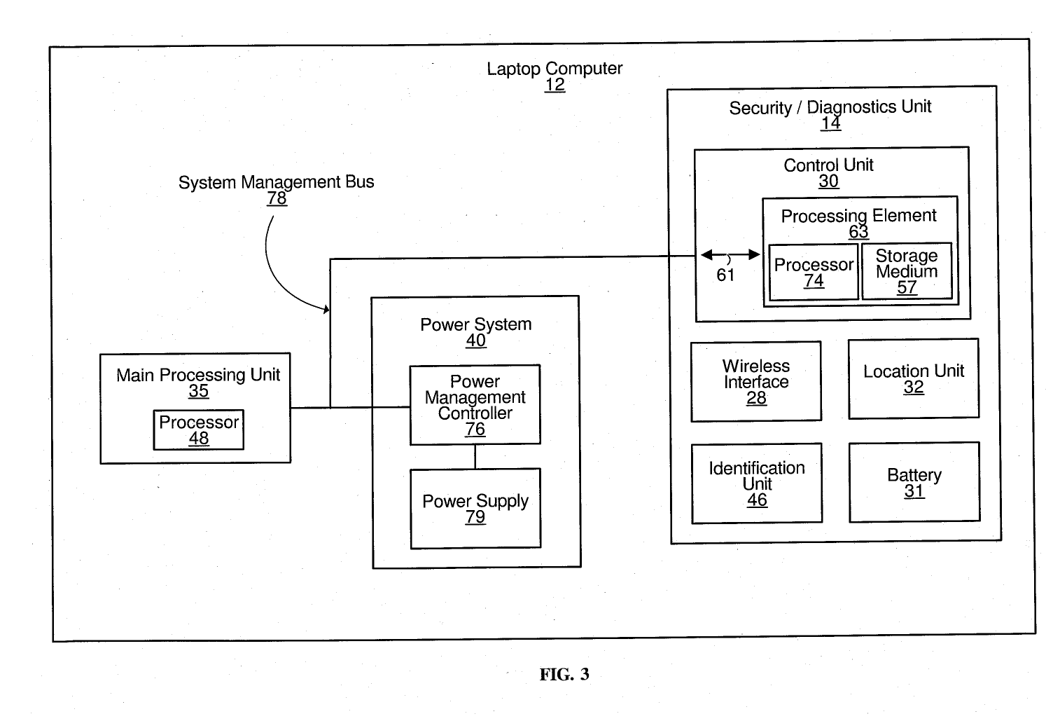

With additional reference to FIG. 3, in this embodiment, the control unit 30 is connected to the power system 40 of the laptop computer 12 by being connected to a power management controller 76 of the laptop computer 12 via a system management bus 78 of the laptop computer 12. That is, the control unit 30 has access to the power management controller 76 of the laptop computer 12 via the system management bus of the laptop computer 12.

The power management controller 76 controls whether power from the laptop computer's power supply 79 is applied or not applied to any component of the laptop computer 12 connected to this power supply. The power management controller 76 may be provided on a main circuit board of the laptop computer 12 during manufacturing of the laptop computer 12.

The system management bus 78 is a bus having access to the power management controller 76 to allow transmission of commands to, and possibly transmission of information (e.g., codes) from, the power management controller 76. The system management bus 78 is provided on the main circuit board of the laptop computer 12 during manufacturing of the laptop computer 12 and interconnects the main processing unit 35 of the laptop computer 12 with various hardware and firmware components of the laptop computer 12, including the power management controller 76. In various embodiments, the system management bus 78 may be configured according to the System Management Bus (SMBus) defined by Intel®, the so-called Power Management Bus (PMBus), any other I²C-derived bus, or any other bus connected to the power management controller 76 of the laptop computer 12.

The control unit 30 can send signals to the power management controller 76 via the system management bus 78 in order to cause the power management controller 76 to change a power state of the laptop computer 12. That is, the control unit 30 can send signals to the power management controller 76 via the system management bus 78 in order to cause the power management controller 76 to allow power to be applied to, apply power to, vary power applied to, stop applying power to, or prevent power from being applied to any component of the laptop computer 12 to which the power supply 79 is connected. These signals convey commands to be executed by the power management controller 76 such that, upon executing these commands, the power management controller 76 changes the power state of the laptop computer 12 in accordance with these commands. In particular, the control unit 30 can send a command instructing the power management controller 76 to shutdown the laptop computer 12 if it is powered on and prevent the laptop computer 12 from being powered on unless the power management controller 76 receives a subsequent command from the control unit 30 instructing the power management controller 76 to allow the laptop computer 12 to be powered on. Also, the control unit 30 can send a command instructing the power management controller 76 to power on the laptop computer 12 when it is powered off. In addition, the control unit 30 can send one or more commands instructing the power management controller 76 to apply power to, vary power applied to, or cease applying power to one or more selected components of the laptop computer 12 in order to perform tests on such components (e.g., verify whether they function correctly).

In some embodiments, the control unit 30 may have access to the system management bus 78 via an interface, such as a Mini-PCI express, a Trusted Platform Module (TPM) or another suitable interface. In other embodiments, the control unit 30 may have direct access to the system management bus 78 when the main circuit board on which is provided this bus is manufactured with the control unit 30 already included. Such main circuit boards, when also equipped with security/diagnostics units such as the security/diagnostics unit 14, can facilitate large-scale deployment of features associated with the wireless security service and/or the wireless technical support service contemplated herein.

It is to be understood that, in other embodiments, the control unit 30 may be connected to the power system 40 of the laptop computer 12 in other manners to control whether power is applied to the laptop computer 12. For example, in some embodiments, the control unit 30 may be connected to the power system 40 of the laptop computer 12 by being directly, connected to the power supply 79 via a direct physical connection thereto, which may include a switch that can be opened or closed by the control unit 30, without intervention of the power management controller 76, in order to prevent or allow the laptop computer 12 from being powered on.

Referring back to FIG. 2, depending on the nature of the wireless network 24, in some embodiments, the security/diagnostics unit 14 may comprise an identification unit 46 allowing the security/diagnostics unit 14 to have access to and communicate over the wireless network 24. In such embodiments, the identification unit 46 stores identification information to identify itself, and thus the security/diagnostics unit 14, on the wireless network 24. For example, the identification information may include an international mobile subscriber identity (IMSI). In some cases, the identification unit 46 may also store authentication information (e.g., an authentication key) to authenticate itself, and thus the security/diagnostics unit 14, on the wireless network 24. For instance, in various embodiments, the identification module 46 may comprise a subscriber identity module (SIM), a universal subscriber identity module (USIM) or a removable user identity module (RUIM). It is noted that, in some embodiments, the identification unit 46 may be omitted from the security/diagnostics unit 14.

The security/diagnostics unit 14 may also comprise a dedicated battery 31 (i.e., a small battery dedicated to the security/diagnostics unit 14) to provide electrical power to the security/diagnostics unit 14 when the laptop computer 12 is not plugged into a power outlet or when a main battery of the laptop computer 12 is depleted or has been removed. The dedicated battery 31 may be connected to a charging circuit of the power system 40 such that it can be recharged when the laptop computer 12 is powered from a power outlet and/or from its main battery.

As it may be used for security purposes, in this embodiment, the security/diagnostics unit 14 is tamperproof, i.e., designed to prevent tampering therewith. The security/diagnostics unit 14 thus has tamperproof features to further enhance security of the laptop computer 12.

In a first tamperproof feature, the control unit 30 is adapted to detect an unauthorized attempt to open the casing of the laptop computer 12. For example, the control unit 30 may be connected to a casing opening detector adapted to produce a signal in response to opening of the casing of the laptop computer 12. Upon receiving the signal produced by the casing opening detector, the control unit 30 may automatically: interact with the power system 40 to turn off the laptop computer 12 (if it is on) and to prevent the laptop computer 12 from being turned on; interact with the memory system 42 to erase, encrypt or otherwise prevent access to data stored in one or more memory elements of the laptop computer 12; and/or interact with the location unit 32 to generate a message indicative of the laptop computer's location and cause transmission of that message to the security/technical support entity 20 via the wireless network 24. As a result, an individual who maliciously or otherwise without authorization opens the casing of the laptop computer 12 (perhaps to remove the security/diagnostics unit 14) would trigger the security/diagnostics unit 14 to automatically disable the laptop computer 12 and communicates its location to the security/technical support entity 20. In situations where the casing of the laptop computer 12 needs to be opened for legitimate reasons (e.g., maintenance or repair), the security/technical support entity 20 may cause transmission of a message to the security/diagnostics unit 14 via the wireless network 24 to command the control unit 30 to not perform the aforementioned actions at a time when this legitimate or authorized opening of the laptop computer's casing is to take place. As a possible alternative to this feature, in some embodiments, rather than detect an unauthorized attempt to open the casing of the laptop computer 12, a similar detector may be implemented to detect an unauthorized attempt to remove the control unit 30.

In a second tamperproof feature, the control unit 30 is linked to the BIOS 43 of the laptop computer 12 such that, without physical presence of the control unit 30, the BIOS 43 is prevented from launching a boot sequence of the laptop computer 12 (i.e., a sequence of operations the laptop computer 12 performs when it is initially powered on leading to loading of its operating system 53). More particularly, there may be provided a link between the control unit 30 and the BIOS 43 such that, if this link is broken or otherwise unavailable, the BIOS 43 is prevented from launching the laptop computer's boot sequence. For example, this link may be implemented by providing program code in the BIOS 43 that looks for and ensures presence of the control unit 30 before allowing the laptop computer 12 to boot. This would cause removal of the control unit 30 to render essentially inoperable the laptop computer 12.

### Wireless Security Service

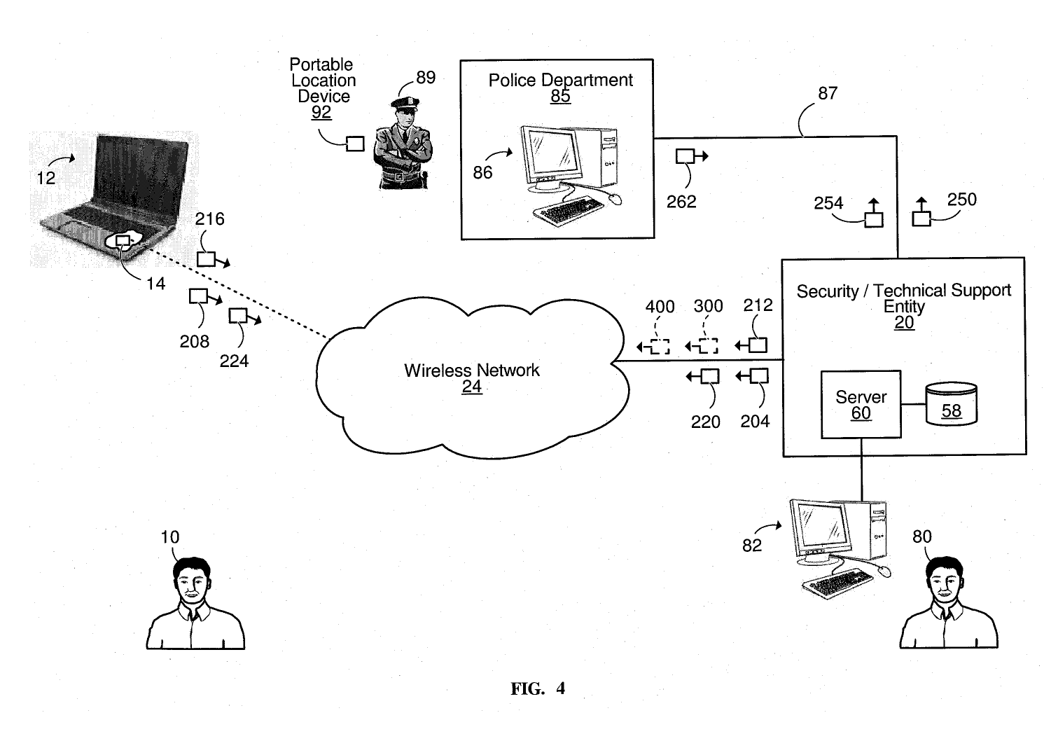

Turning now to FIG. 4, interaction between the security/diagnostics unit 14 of the laptop computer 12 and the security/technical support entity 20 as part of the wireless security service will be illustrated in the context of an example scenario where the user 10 realizes that the laptop computer 12 has been stolen or lost or is otherwise missing. For purposes of this example, it is assumed that the user 10 subscribes to the wireless security service further a registration phase for this service, an example of which is further discussed later on.

The user 10 contacts the service provider providing the wireless security service to report that the laptop computer 12 has been stolen or lost or is otherwise missing. In this embodiment, the user 10 contacts a customer service representative 80 of the service provider to report the situation. The customer service representative 80 uses a computer 82 communicatively coupled to a server 60 of the security/technical support entity 20.

The server 60 comprises suitable hardware and/or software for implementing a plurality of functional components, including an interface and a processing unit. The interface of the server 60 implements one or more inputs and outputs for receiving and sending messages from and to integrated wireless communication units of laptop computers (such as the security/diagnostics unit 14 of the laptop computer 12) via the wireless network 24. The interface of the server 60 may also receive and send messages from and to computers (such as the computer 82), databases and/or other elements communicatively coupled to that server. The processing unit of the server 60 comprises one or more processors for performing processing operations to implement functionality of that server. A given one of these one or more processors may be a general-purpose processor having access to a storage medium (e.g., semiconductor memory, including one or more ROM and/or RAM memory devices) storing program code for execution by that processor to implement functionality of the server 60. Alternatively, a given one of these one or more processors may be a specific-purpose processor comprising one or more pre-programmed hardware or firmware elements (e.g., application-specific integrated circuits (ASICs), electrically erasable programmable read-only memories (EEPROMs), etc.) or other related elements to implement functionality of the server 60.

The customer service representative 80 proceeds to identify and authenticate the user 10 as being a subscriber to the wireless security service. In this embodiment, the customer service representative 80 requests from the user 10 a subscriber identifier obtained by the user 10 during the registration phase for the wireless security service. The customer service representative 80 may also request from the user 10 other information to authenticate the user 10. For example, the customer service representative 80 may request the user 10 to provide personal information (e.g., his/her name, date of birth, etc.) and/or contact information (e.g., his/her telephone number, civic address, email address, etc).

Based on the subscriber identifier provided by the user 10, the customer service representative 80 uses the computer 82 to access via the server 60 a database 58 containing records associated with subscribers to the wireless security service. A record in the database 58 associated with a given subscriber, which can be viewed as an account for the given subscriber, includes a subscriber identifier (e.g., an account number, a name, etc.) to identify the given subscriber. The record associated with the given subscriber may also include registration information provided by the given subscriber during the registration phase. For example, the registration information may include personal information regarding the given subscriber (e.g., a name, date of birth, etc.), contact information regarding the given subscriber (e.g., a telephone number, civic address, email address, etc.), billing information (e.g., credit card information), and laptop computer information regarding the given subscriber's laptop computer (e.g., serial number, manufacturer's name, model).

Thus, in this example, the database 58 contains a record associated with the user 10 and containing the subscriber identifier obtained by the user 10 during the registration phase as well as registration information provided by the user 10 during the registration phase. The customer service representative 80 concludes by comparing the information provided by the user 10 to the registration information contained in the record that the user 10 is indeed a subscriber to the wireless security service.

The customer service representative 80 interacts with the computer 82 to cause the server 60 to transmit a message 204 to the security/diagnostics unit 14 of the laptop computer 12 via the wireless network 24. It is assumed that, prior to transmission of the message 204, the security/diagnostics unit 14 is in a sleep mode where any current function of the control unit 30 is either shut down completely or its speed of operation is reduced to limit power consumption. The message 204 conveys a command to put the security/diagnostics unit 14 in a wake mode.

In response to receiving the message 204, the security/diagnostics unit 14 puts itself in wake mode. In wake mode, the processor 74 of the processing element 63 of the security/diagnostics unit 14 operates at a higher frequency in order to process commands faster. The security/diagnostics unit 14 also sends a message 208 to the server 60 via the wireless network 24 to acknowledge receipt of the message 204 and confirm that it is in wake mode.

Upon receiving the message 208, the server 60 determines that the security/diagnostics unit 14 has received the message 204 and placed itself in wake mode. The server 60 proceeds to transmit a message 212 to the security/diagnostics unit 14 via the wireless network 24. The message 212 conveys a command to shutdown the laptop computer 12.

In response to receiving the message 212, the security/diagnostics unit 14 interacts with the power system 40 of the laptop computer 12 in order to shutdown the laptop computer 12. In this case, the control unit 30 interacts with the power system 40 to determine whether the laptop computer 12 is on or off. If the control unit 30 determines that the laptop computer 12 is on, the control unit 30 sends one or more signals to the power system 40 to turn off the laptop computer 12 and prevent it from being turned on. More particularly, in this embodiment, the control unit 30 sends one or more commands instructing the power management controller 76 to shutdown the laptop computer 12 and prevent the laptop computer 12 from being powered on unless the power management controller 76 receives a subsequent command from the control unit 30 instructing the power management controller 76 to allow the laptop computer 12 to be powered on. On the other hand, if the control unit 30 determines that the laptop computer 12 is off, the control unit 30 sends a signal to the power system 40 to prevent the laptop computer 12 from being turned on. More particularly, in this embodiment, the control unit 30 sends a command instructing the power management controller 76 to prevent the laptop computer 12 from being powered on unless the power management controller 76 receives a subsequent command from the control unit 30 instructing the power management controller 76 to allow the laptop computer 12 to be powered on. Upon shutting down the laptop computer 12, the security/diagnostics unit 14 sends a message 216 to the server 60 via the wireless network 24 to acknowledge receipt of the message 212 and confirm that the laptop computer 12 has been shutdown.

Upon receiving the message 216, the server 60 determines that the security/diagnostics unit 14 has received the message 212 and that the laptop computer 12 has been shutdown.

The server 60 proceeds to transmit a message 220 to the security/diagnostics unit 14 via the wireless network 24. The message 220 conveys a request to obtain a location of the laptop computer 12.

Upon receiving the message 220, the location module 32 of the security/diagnostics unit 14 determines a location of the laptop computer 12 based on one or more signals wirelessly received by the location module 32. As mentioned above, the location of the laptop computer 12 may be expressed as a set of geo-coordinates, including latitude, longitude and altitude coordinates.

The security/diagnostics unit 14 proceeds to transmit a message 224 to the server 60 via the wireless network 24. The message 224 conveys the location of the laptop computer 12.

Upon receiving the message 224, the server 60 processes it to obtain the location of the laptop computer 12. In cases where the location of the laptop computer 12 conveyed by the message 224 is expressed as a set of geo-coordinates, the server 60 may process the geo-coordinates to derive a civic address corresponding to the geo-coordinates. In such cases, the location of the laptop computer 12 known by the server 60 can be expressed as the set of geo-coordinates and/or the civic address derived therefrom.

In order to allow the server 60 to track the laptop computer 12 until it is recovered, the security/diagnostics unit 14 can repeatedly (e.g., periodically) determine an updated location of the laptop computer 12 and transmit messages similar to the message 224 to the server 60 via the wireless network 24. By processing these messages, the server 60 can keep track of the updated location of the laptop computer 12.

Based on the location of the laptop computer 12, an attempt to recover the laptop computer 12 can be made. In particular, in this embodiment, police authorities can be informed of likely whereabouts of the laptop computer 12 and can attempt to recover it.

More particularly, while or shortly after the user 10 speaks with the customer service representative 80, the service provider communicates with a police department 85 to inform the police department 85 that the laptop computer 12 has been stolen or lost or is otherwise missing. The police department 85 may have jurisdiction in an area where the laptop computer 12 has been stolen or lost or has otherwise gone missing. This area may be determined by the service provider based on a residential address of the user 10 and stored in the record in the database 58 which is associated with the user 10, or based on information provided to the customer service representative 80 by the user 10 (e.g., a place from which the user 10 is calling or a place where the user 10 indicates the laptop computer 12 has been stolen or lost or has otherwise gone missing).

Communication between the service provider and the police department 85 may be effected in various ways. For example, in one embodiment, the customer service representative 80 may use the computer 82 to cause the server 60 to send a message 250 via a communication link 87 to a computer 86 associated with the police department 85. The communication link 87 may be established over a network, which may comprise part of a data network (e.g., the Internet), a public telephony network and/or another network. Alternatively, the communication link 87 may be a dedicated communication link. The message 250 indicates that the laptop computer 12 has been stolen or lost or is otherwise missing and conveys the laptop computer information (e.g., manufacturer's name, model, serial number) identifying the laptop computer 12 and obtained from the record in the database 58 associated with the user 10. In another embodiment, the customer service representative 80 may call an individual (e.g., a police officer) working at the police department 85 to indicate that the laptop computer 12 has been stolen or lost or is otherwise missing and to convey the laptop computer information identifying the laptop computer 12.

While interacting with the user 10, the customer service representative 80 advises the user 10 to file a police report with the police department 85 to report that the laptop computer 12 has been stolen or lost or is otherwise missing and to inform the police department 85 that the service provider has been notified of this situation and should be contacted to obtain the location of the laptop computer 12. For purposes of this example, assume that the user 10 proceeds as advised.

It is recalled that, based on the message 224 (and possibly other similar messages) transmitted by the security/diagnostics unit 14, the server 60 has knowledge of the location of the laptop computer 12, which can be expressed as the set of geo-coordinates and/or the civic address identifying where the laptop computer 12 is located.

The service provider communicates the location of the laptop computer 12 (i.e., the set of geo-coordinates and/or the civic address) to the police department 85. Here again, communication between the service provider and the police department 85 may be effected in various ways. For example, in one embodiment, the customer service representative 80 may use the computer 82 to cause the server 60 to send a message 254 via the communication link 87 to the computer 86 associated with the police department 85. The message 254 conveys the location of the laptop computer 12 as well as the laptop computer information (e.g., manufacturer's name, model, serial number) identifying the laptop computer 12 and obtained from the record in the database 58 associated with the user 10. In another embodiment, the customer service representative 80 may call an individual (e.g., a police officer) working at the police department 85 to communicate the location of the laptop computer 12 as well as the laptop computer information identifying the laptop computer 12.

The police department 85 obtains the location of the laptop computer 12 (i.e., the set of geo-coordinates and/or the civic address) as well as the laptop computer information identifying the laptop computer 12. Based on the laptop computer information identifying the laptop computer 12, and since the user 10 filed the police report reporting that the laptop computer 12 has been stolen or lost or is otherwise missing, the police department 85 can make an attempt to recover the laptop computer 12 using the obtained location of the laptop computer 12. This involves one or more police officers 89 associated with the police department 85 going to a building or other place corresponding to the obtained location of the laptop computer 12 and attempting to recover the laptop computer 12. In some cases, this may also involve the one or more police officers requesting a search warrant to access the building or other place in order to attempt to recover the laptop computer 12.

To facilitate an attempt to recover the laptop computer 12, in this embodiment, the one or more police officers 89 may use a portable location device 92. The portable location device 92, which may have been previously provided to the police department 85 by the service provider, comprises a user interface, a location unit, and a processing unit.

The user interface of the portable location device 92 comprises a display and possibly one or more other output devices (e.g., speakers) and one or more input devices (e.g., a keyboard, a touchscreen, a stylus, a microphone, etc.). The processing unit of the portable location device 92 comprises one or more processors for performing processing operations to implement functionality of the portable location device 92. A given one of these one or more processors may be a general-purpose processor having access to a storage medium (e.g., semiconductor memory, including one or more ROM and/or RAM memory devices) storing program code for execution by that processor to implement functionality of the portable location device 92. Alternatively, a given one of these one or more processors may be a specific-purpose processor comprising one or more pre-programmed hardware or firmware elements (e.g., application-specific integrated circuits (ASICs), electrically erasable programmable read-only memories (EEPROMs), etc.) or other related elements to implement functionality of the portable location device 92.

The one or more police officers 89 may use the user interface of the portable location device 92 to enter therein the location of the laptop computer 12 (i.e., the set of geo-coordinates and/or the civic address) obtained from the service provider. Once entered, the location of the laptop computer 12 is set as a “target location” by the processing unit of the portable location device 92.

The location unit of the portable location device 92 is adapted to wirelessly receive one or more signals and determine a location of the portable location device 92 based on these one or more signals. The location of the portable location device 92 may be expressed as a set of geo-coordinates, including latitude, longitude and altitude coordinates. For example, the location unit of the portable location device 92 may be a GPS receiver adapted to wirelessly receive signals from GPS satellites and determine the location of the portable location device 92 based on these signals.

The processing unit of the portable location device 92 is adapted to cause the display of the portable location device 92 to display the target location (i.e., the location of the laptop computer 12) and the location of the portable location device 92. For example, where the target location and the location of the portable location device 92 are expressed as two sets of geo-coordinates, these two sets of geo-coordinates may be displayed on the display of the portable location device 92. Optionally or alternatively, two graphical elements (e.g., points) respectively corresponding to the target location and the location of the portable location device 92 may be displayed on the display of the portable location device 92.

The one or more police officers 89 can thus use the portable location device 92 in order to attempt recovering the laptop computer 12. More particularly, the one or more police officers 89, carrying the portable location device 92, go to the building or other place corresponding to the obtained location of the laptop computer 12. If needed, the portable location device 92 may be used to guide the one or more police officers to a precise area corresponding to the target location (i.e., the obtained location of the laptop computer 12). This may be particularly useful in cases where the laptop computer 12 is located in a multi-unit building (e.g., a condominium building or other apartment building, an office building, etc.). In such cases, the one or more police officers 89 may circulate in the multi-unit building until the portable location device 92 indicates that the location of the portable location device 92 matches the target location (i.e., the obtained location of the laptop computer 12), at which point the one or more police officers 89 conclude that they arrived at the precise area (e.g., a specific unit of the multi-unit building) where the laptop computer 12 is located.

In some embodiments, in cases where the laptop computer 12 is located in a multi-unit building, the server 60 may, in processing the geo-coordinates conveyed by the message 224 to derive the civic address corresponding to the geo-coordinates, determine that this civic address corresponds to the multi-unit building. Upon making such a determination, the server 60 may proceed to derive an indication of a region of the multi-unit building in which the laptop computer 12 is located based on the altitude coordinate conveyed by the message 224. For example, this indication may be an indication of a story of the multi-unit building or an indication of an upper-half or lower-half region of the multi-unit building. The indication of a region of the multi-unit building in which the laptop computer 12 is located may then be communicated to the police department 85 as part of the message 254. This may be useful in situations where the portable location device 92 is not available to the one or more police officers 89.

Upon arriving at the obtained location of the laptop computer 12, the one or more police officers 89 may attempt to recover the laptop computer 12. As mentioned above, in some cases, this may involve the one or more police officers 89 having a search warrant. For purposes of this example, assume that the one or more police officers 89 recover the laptop computer 12 (possibly after having obtained a search warrant).

Following this recovery, the police department 85 communicates with the service provider to report that the laptop computer 12 has been recovered. Here again, communication between the service provider and the police department 85 may be effected in various ways. For example, in one embodiment, an individual (e.g., a police officer) working at the police department 85 may use the computer 86 to send a message 262 via the communication link 87 to the server 60. The message 262 indicates that the laptop computer 12 has been recovered and conveys the laptop computer information (e.g., manufacturer's name, model, serial number) identifying the laptop computer 12. In another embodiment, an individual (e.g., a police officer) working at the police department may call the customer service representative 80 to indicate that the laptop computer 12 has been recovered and to convey the laptop computer information (e.g., manufacturer's name, model, serial number) identifying the laptop computer 12.

Upon being informed that the laptop computer 12 has been recovered, the customer service representative 80 contacts the user 10 to report this recovery. Since the user 10 had filed the aforementioned police report with the police department 85, the police department 85 may also contact the user 10 to report that the laptop computer 12 has been recovered.

With additional reference to FIG. 5, after going to the police department 85 and taking possession of the laptop computer 12, the user 10 contacts the service provider to report that the laptop computer 12 is now back in his/her possession.

In this embodiment, the user 10 contacts the customer service representative 80 to report that the laptop computer 12 is now back in his/her possession. The customer service representative 80 proceeds to identify and authenticate the user 10 as being a subscriber to the wireless security service. To that end, the customer service representative 80 requests from the user 10 the aforementioned subscriber identifier obtained by the user 10 during the registration phase as well as other information to authenticate the user 10. For example, the customer service representative 80 may request the user 10 to provide personal information (e.g., his/her name, date of birth, etc.) and/or contact information (e.g., his/her telephone number, civic address, email address, etc).

The customer service representative 80 uses the computer 82 to enter the subscriber identifier provided by the user 10 and accesses via the server 60 the record associated with the user 10 and included in the database 58 to view the registration information contained in that record. Since the user 10 has indeed registered for the laptop wireless security service, the customer service representative 80 concludes by comparing the information provided by the user 10 to the registration information contained in the record that the user 10 is indeed a subscriber to the laptop computer recovery service.

The customer service representative 80 uses the computer 82 to cause the server 60 to transmit a message 270 to the security/diagnostics unit 14 via the wireless network 24. The message 270 conveys a command to allow the laptop computer 12 to be turned on.

In response to receiving the message 270, the security/diagnostics unit 14 interacts with the power system 40 of the laptop computer 12 in order to allow the laptop computer 12 to be turned on. In this case, the control unit 30 sends one or more signals to the power system 40 to allow the laptop computer 12 to be turned on. More particularly, in this embodiment, the control unit 30 sends a command instructing the power management controller 76 to allow the laptop computer 12 to be powered on. Upon allowing the laptop computer 12 to be powered on, the security/diagnostics unit 14 sends a message 274 to the server 60 via the wireless network 24 to acknowledge receipt of the message 270 and confirm that the laptop computer 12 has been allowed to be turned on.

Upon receiving the message 274, the server 60 determines that the security/diagnostics unit 14 has received the message 270 and that the laptop computer 12 has been allowed to be turned on. The user 10 is then instructed by the customer service representative 80 to turn on the laptop computer 12, and proceeds to turn it on. Alternatively, the customer service representative 80 may use the computer 82 to cause the server 60 to transmit a message (not shown) to the security/diagnostics unit 14 via the wireless network 24 to convey a command instructing the power management controller 76 to turn on the laptop computer 12. In either case, the user 10 confirms to the customer service representative 80 that the laptop computer 12 has been turned on.

The server 60 proceeds to transmit a message 278 to the security/diagnostics unit 14 via the wireless network 24. The message 278 conveys a command to put the security/diagnostics unit 14 in sleep mode.

In response to receiving the message 278, the security/diagnostics unit 14 puts itself in sleep mode. The security/diagnostics unit 14 also sends a message 282 to the server 60 via the wireless network 24 to acknowledge receipt of the message 278 and confirm that it is in sleep mode.

Upon receiving the message 282, the server 60 determines that the security/diagnostics unit 14 has received the message 278 and placed itself in sleep mode. The server 60 concludes that the security/diagnostics unit 14 is operating correctly and that the wireless security service can continue to be provided. The customer service representative 80 informs the user 10 of this and terminates their call.

It will thus be appreciated that the wireless security service can allow the stolen, lost or otherwise missing laptop computer 12 to be recovered in an efficient and convenient manner.

It will also be appreciated that, in other embodiments, various other interactions may take place between the security/technical support entity 20 and the security/diagnostics unit 14 of the laptop computer 12 as part of the wireless security service.

For example, in some embodiments, the security/technical support entity 20 may interact with the security/diagnostics unit 14 of the laptop computer 12 in order to prevent access to data stored in the memory system 42 of the laptop computer 12. More particularly, as shown in FIG. 4, the server 60 may transmit a message 300 to the security/diagnostics unit 14 via the wireless network 24, the message 300 conveying a command to erase, encrypt or otherwise prevent access to data stored in one or more memory elements of the memory system 42 of the laptop computer 12. For instance, this can be effected by the server 60 autonomously as a default procedure or in response to input from the customer service representative 80, who may have confirmed with the user 10 that such a command is to be transmitted.

Upon receiving the message 300, the control unit 30 sends a control signal to the memory system 42 to erase, encrypt or otherwise prevent access to data stored in one or more memory elements of the memory system 42. In some embodiments, if and when the laptop computer 12 is recovered by the user 10 in cases where interaction of the control unit 30 and the memory system 42 in response to the message 300 resulted in the data stored in the one or more memory elements being encrypted or otherwise retrievable, it may be possible to retrieve this data (e.g., the server 60 may transmit a message to the security/diagnostics unit 14 to instruct the control unit 30 to decrypt the data).

As another example, in some embodiments, the security/technical support entity 20 may interact with the security/diagnostics unit 14 of the laptop computer 12 in order to corrupt the booting instructions 51 implemented by the BIOS 43, thereby further rendering the laptop computer 12 inoperable. More particularly, as shown in FIG. 4, the server 60 may transmit a message 400 to the security/diagnostics unit 14 via the wireless network 24, the message 400 conveying a command to corrupt the booting instructions 51 implemented by the BIOS 43 of the laptop computer 12.

Upon receiving the message 400, the control unit 30 proceeds to send a control signal to the storage system 42 to cause the booting instructions 51 implemented by the BIOS 43 to become corrupted such that the laptop computer 12 is prevented from booting properly thereafter. For example, the control unit 30 may cause at least a portion of the program code defining the booting instructions 51 to be erased such that the laptop computer 12 is prevented from booting properly thereafter. Alternatively, the control unit 30 may cause at least a portion of the program code defining the booting instructions 51 to be replaced by improper program code such that the laptop computer 12 is prevented from booting properly thereafter. The improper program code is incorrect or incomprehensive program code which, when executed by the main processing unit 35 of the laptop computer 12, prevents the laptop computer 12 from booting properly. For example, the improper program code may contain a string of senseless alphanumeric characters and/or may specify that the main processing unit 35 is to read an inexistant memory location or an incorrect memory location. Thus, if the laptop computer 12 is powered off when the control unit 30 receives the message 400, such corruption of the booting instructions 51 acts to prevent the laptop computer 12 from booting properly when turned on, thereby rendering the laptop computer 12 inoperable

In some cases, upon receiving the message 400 (or a similar message transmitted by the server 60) the control unit 30 may cause other program code in the BIOS 43 that is executed when carrying out one or more basic functions of the laptop computer 12 to be erased or replaced by improper program code such that these one or more basic functions are prevented from being carried out properly thereafter. Examples of such basic functions include a print function, a shortcut key combination function (e.g., “Ctrl”+“c” for copying to a clipboard, etc.), or a peripheral hardware device (e.g., a mouse, a network adapter, etc.) function which relies on program code in the BIOS 43 to be carried out. In that way, if the laptop computer 12 is powered on when the control unit 30 receives the message 400, once the program code in the BIOS 43 executed when carrying out such one or more basic functions is erased and/or replaced by improper program code, the one or more basic functions may begin to fail and possibly cause the operating system 53 of the laptop computer 12 to crash. Upon attempting to reboot the laptop computer 12 after such a crash, the corrupted BIOS 43 prevents the laptop computer 12 from booting properly.

Although in this embodiment the user 10 may report to the service provider that the laptop computer 12 has been stolen or lost or is otherwise missing by contacting the customer service representative 80 of the service provider, the user 10 may report this to the service provider in other manners in other embodiments. For example, in some embodiments, the user 10 may use another computer to access and interact with a network site (e.g., a web site) implemented by the security/technical support entity 20 in order report to the service provider that the laptop computer 12 has been stolen or lost or is otherwise missing.

### Wireless Technical Support Service

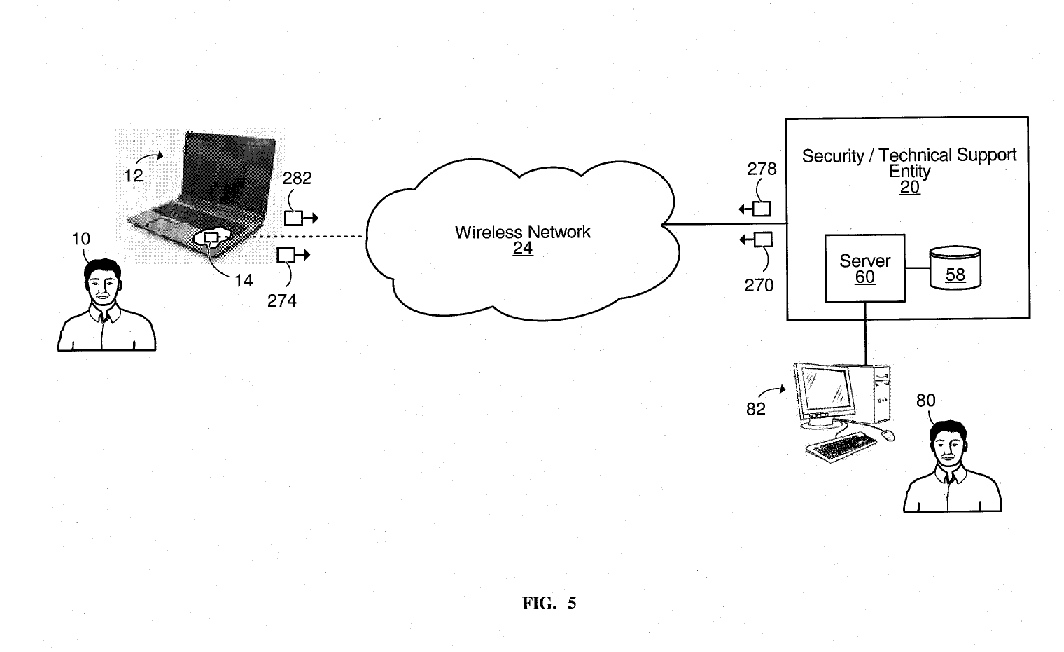

Turning now to FIG. 6, interaction between the security/diagnostics unit 14 of the laptop computer 12 and the security/technical support entity 20 as part of the wireless technical support service will be illustrated in the context of an example scenario where certain troubleshooting, software and/or hardware modifications, or other maintenance and/or diagnostics activities may need to be carried out on the laptop computer 12. For purposes of this example, it is assumed that the user 10 subscribes to the wireless technical support service further a registration phase for this service, an example of which is further discussed later on.

In this example, the user 10 contacts the service provider providing the wireless technical support service to request that certain maintenance and/or diagnostics activities be performed on the laptop computer 12. For example, the user 10 may report that there is a problem with the laptop computer 12 which is not functioning properly or may ask for certain software and/or hardware modifications to be made. To that end, in this embodiment, the user 10 contacts a technician 90 of the service provider. The technician uses a computer 83 communicatively coupled to the server 60 of the security/technical support entity 20.

The technician 90 proceeds to identify and authenticate the user 10 as being a subscriber to the wireless technical support service. In this embodiment, the technician 90 requests from the user 10 a subscriber identifier obtained by the user 10 during the registration phase for the wireless technical support service. The technician 90 may also request from the user 10 other information to authenticate the user 10. For example, the technician 90 may request the user 10 to provide personal information (e.g., his/her name, date of birth, etc.) and/or contact information (e.g., his/her telephone number, civic address, email address, etc). Based on the subscriber identifier provided by the user 10, the technician 90 uses the computer 83 to access via the server 60 the database 58 containing records associated with subscribers to the wireless technical support service. Thus, in this example, the database 58 contains a record associated with the user 10 and containing the subscriber identifier obtained by the user 10 during the registration phase as well as registration information (e.g., personal information, contact information, billing information, laptop computer information) provided by the user 10 during the registration phase. The technician 90 concludes by comparing the information provided by the user 10 to the registration information contained in the record that the user 10 is indeed a subscriber to the wireless technical support service.

It is to be understood that, in other examples, the technician 90 of the service provider may undertake remote technical support activities without the user 10 having specifically requested such activities to be undertaken at that time. For example, the technician 90 may in some cases proceed to remotely upgrade certain software on the laptop computer 12 without having been specifically requested by the user 10.

The technician 90 can interact with the computer 83 to cause the server 60 to transmit one or more messages 500 to the security/diagnostics unit 14 of the laptop computer 12 via the wireless network 24 in order to perform various technical support activities. The one or more messages 500 convey one or more diagnostics and/or maintenance commands (which can also be referred to as “technical support commands”) provided by the technician 90 by interacting with the computer 83. The security/diagnostics unit 14 is designed to perform one or more diagnostics and/or maintenance operations on the laptop computer 12 based on these one or more diagnostics and/or maintenance commands. More particularly, the one or more messages 500 conveying the one or more diagnostics and/or maintenance commands are received by the wireless interface 28, which processes these one or more messages to extract command information indicative of the one or more diagnostics and/or maintenance commands and conveys the command information to the control unit 30. The processing element 63 of the control unit 30 processes the command information and then issues one or more control signals to various components of the laptop computer 12 via the interface 61 of the control unit 30 in order to carry out the one or more diagnostics and/or maintenance operations.

A wide variety of diagnostic and/or maintenance commands can be used by the technician 90 to perform diagnostic and/or maintenance operations on the laptop computer 12. Examples of such technical support commands are provided below.

### 1. Diagnostic Commands

a. Powering up command—This command is used by the technician 90 to start the laptop computer 12 such that the laptop computer 12 goes through a booting operation which is then followed by loading and execution of the kernel of the operating system 53.
b. Powering down command—This command is used by the technician 90 to shut down the laptop computer 12. In this embodiment, the powering up and powering down commands are implemented by interfacing the security/diagnostics unit 14 with the power management controller 76 of the laptop computer 12.
c. Hardware component and/or software component verification commands—These commands are used by the technician 90 to verify whether one or more specific hardware components and/or software components are functioning correctly. In this embodiment, these commands are implemented by interfacing the security/diagnostics unit 14 with various hardware and/or software components of the laptop computer 12 via the system management bus 78, by connection to a “southbridge” (also known as “I/O controller hub”) of the laptop computer's motherboard (in some cases, the security/diagnostics unit 14 may also be linked to a “northbridge” (also known as “memory controller hub” of the laptop computer's motherboard).
The technician 90 may decide which commands are to be sent based on information provided by the user 10 (e.g., a description of the problem that the user 10 faces). For example, in a case where the user 10 indicates that the laptop computer 12 is unable to connect to the Internet, the technician 90 may cause the server 60 to transmit commands to test that a modem of the laptop computer 12 is operating normally, that the laptop computer 12 has an Internet connection, that a browser of the laptop computer 12 functions normally, etc., to pinpoint the problem and take steps to solve it.
In this embodiment, as the control unit 30 operates independently of the main processing unit 35 of the laptop computer 12 that implements the booting instructions 51 and the operating system 53, the technician 90 can send commands to diagnose a problem at a pre-boot level or BIOS level before the operating system 53 is loaded. This allows the technician 90 to determine whether the BIOS and the operating system 53 themselves are operating correctly.

### 2. Maintenance Commands

a. Information upload command—This command can be used by the technician 90 to upload certain information, such as software (e.g., drivers, applications, etc.) and/or content (e.g., data files), into the storage system 42 of the laptop computer 12. In this embodiment, the information upload command is implemented by interfacing the security/diagnostics unit 14 with the storage system 42 of the laptop computer 12. For example, the user 10 may be employed by a company having a proprietary software application that needs to be updated regularly (e.g., an insurance company having a quoting software application that needs to be updated regularly to ensure that quotes are accurate and up to date), in which case the technician 90 may periodically check which version of this software application is available on the laptop computer 12 and update it to its most current version when necessary.
b. Configuration command—This command can be used by the technician 90 to configure hardware and/or software components of the laptop computer 12. For instance, this can be used to change settings of application software used by the user 10 or settings of a hardware device driver. In this embodiment, these commands are implemented by interfacing the security/diagnostics unit 14 with various hardware and/or software components of the laptop computer 12 via the system management bus 78, by connection to the southbridge of the laptop computer's motherboard.

Thus, the one or more messages 500 transmitted to the security/diagnostics unit 14 may convey commands for the control unit 30 to: obtain information regarding various software components of the laptop computer 12, including its booting instructions 51, its operating system 53 and other software components; obtain information regarding various hardware components of the laptop computer 12 (e.g., its hard drive, power supply, fan, etc.); upload information (e.g., drivers, applications, etc.) to the memory system 42 of the laptop computer 12; perform one or more tests to test functionality of various hardware and/or software components of the laptop computer 12; and/or perform various other diagnostic and/or maintenance operations on the laptop computer 12.

Information regarding hardware and/or software components that can be obtained by the control unit 30 may be conveyed into one or more messages 520 transmitted by the control unit 30 to the server 60 via the wireless interface 28 and the wireless network 24. This information can be very useful to the technician 90 in carrying out its technical support activities.

In particular, as it can operate independently of the booting instructions 51 of the laptop computer 12, the control unit 30 can operate before and/or during the boot sequence of the laptop computer 12 and actually “see” that boot sequence as it unfolds. To that end, the control unit 30 monitors operations performed by the laptop computer 12 as part of the booting sequence under control of the booting instructions 51. Based on this monitoring, the control unit 30 obtains information about the boot sequence of the laptop computer 12. For example, such information may include: a list of operations performed by the booting instructions 51 (e.g., operations performed as part of the power-on test, memory reading operations); error codes (e.g., codes indicative of unfound or defective hardware components) information regarding a start-up screen of the BIOS 43 which may normally be displayed on the display 38 (e.g., BIOS manufacturer and version, BIOS date, BIOS serial number, setup program key, etc.); and/or information regarding a summary screen of a system configuration of the laptop computer 12 which may normally be displayed on the display 38 (e.g., hardware list, processor type, display type; plug and play devices, etc.). In some cases, one or more messages 500 transmitted to the security/diagnostics unit 14 may be indicative of a request for the information about the boot sequence of the laptop computer 12. The control unit 30 may then cause the information regarding the boot sequence of the laptop computer 12 to be conveyed by one or more messages 520 transmitted to the server 60 via the wireless interface 28 and the wireless network 24. The information about the boot sequence of the laptop computer 12 can be very useful to the technician 90 in deriving a diagnostic for a problem affecting the laptop computer 12, particularly in cases where the laptop computer 12 is not booting at all or is booting improperly.

In this embodiment, the security/diagnostics unit 14 remains active when the laptop computer 12 is powered down, such as to be able to sense commands (e.g., diagnostic and/or maintenance commands) that are being sent to it. Electrical power can be provided to the security/diagnostics unit 14 by the dedicated battery 31, by the main battery of the laptop computer 12 when available, or by a power outlet to which the laptop computer 12 is coupled when available. Different power supply schemes are therefore possible for the security/diagnostics unit 14. For example:
1. The security/diagnostics unit 14 may be powered by a non-battery power supply of the laptop computer 12 that is fed by a power outlet.
2. The security/diagnostics unit 14 may be powered by the main battery of the laptop computer 12 (e.g., when the laptop computer 12 is not coupled to a power outlet).
3. The security/diagnostics unit 14 may be powered by the dedicated battery 31. The dedicated battery 31 has a sufficient capacity to maintain the security/diagnostics unit 14 active for a predetermined period of time. Naturally, the larger the dedicated battery 31 is, the longer the security/diagnostics unit 14 can remain operational. As mentioned previously, the dedicated battery 31 may be a rechargeable battery that can be connected to the charging circuit of the laptop computer 12 such that it can be recharged when the laptop computer 12 is powered from a power outlet or by its main battery where no power outlet is coupled to the laptop computer 12.

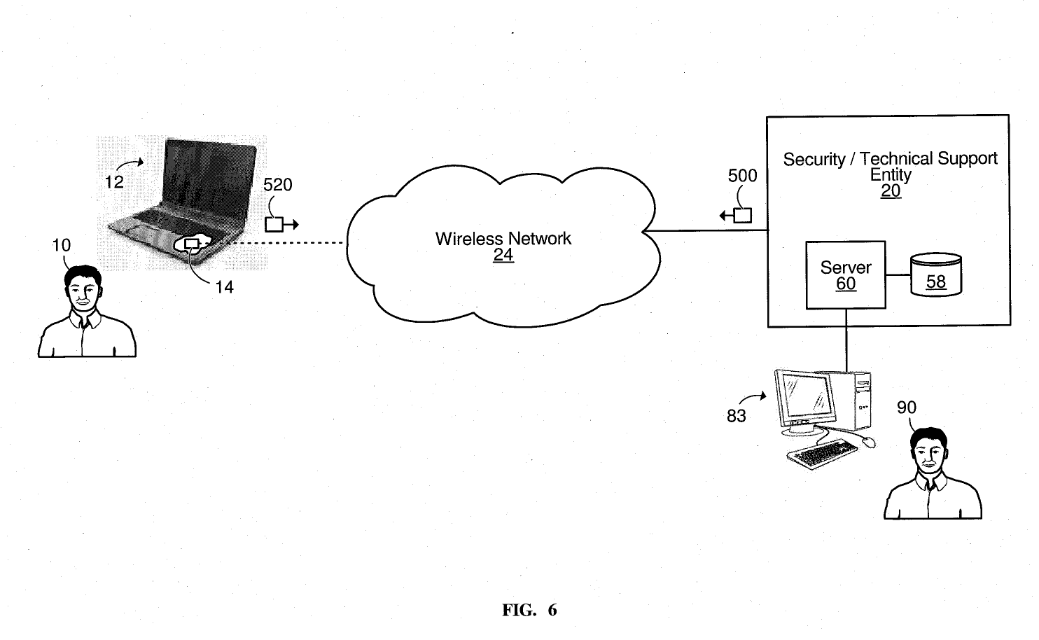

In some cases, such as where the security/diagnostics unit 14 is powered by a battery, either the dedicated battery 31 or the main battery of the laptop computer 12, certain power management schemes can be considered to reduce power consumption of the security/diagnostics unit 14. A flowchart illustrating an example of a process to manage the power consumption is shown in FIG. 7. In this example, at step 1000, it is assumed that the security/diagnostics unit 14 is in a low-power mode (also referred to as a “sleep mode”), which is a mode of operation where any hardware that is not required for any current function is either shut down completely or its speed of operation is reduced to limit power consumption. For instance, a frequency of the processor 74 of the processing element 63 may be reduced to limit power consumption. However, the wireless interface 28 is maintained active to continue sensing for presence of wireless signals that convey commands, such as diagnostic and/or maintenance commands, as shown at step 1002.

Logic implemented by the security/diagnostics unit 14 is in a loop, as shown by decision block 1004. The loop senses the presence of signals picked up by the wireless interface 28. If no signals are found that convey commands, then the security/diagnostics unit 14 is currently maintained in the low-power mode. However, if commands are sensed, in particular a “wake” command, then the security/diagnostics unit 14 switches to a higher-power mode (also referred to as a “wake mode”), as shown at step 1006, to perform necessary processing of the commands. An example of a higher-power mode is to drive the processor 74 of the processing element 63 at a higher frequency so it can execute code faster.

In some embodiments, the “wake” command to cause the security/diagnostics unit 14 to switch to the higher-power mode may be conveyed by a message having a format different from that of subsequent messages conveying commands, such as diagnostic and/or maintenance commands, to be carried out on the laptop computer 12. For instance, the wake command to cause the security/diagnostics unit 14 to switch to the higher-power mode may be conveyed by a message having a standard or commonly-used format in the wireless network 24 (e.g., a short message service (SMS) message), while subsequent messages conveying commands, such as diagnostic and/or maintenance commands, to be carried out on the laptop computer 12 may have another format that may or may not be standard or commonly-used in the wireless network 24 but that is understood by the control unit 30 of the security/diagnostics unit 14.

After the commands have been processed and the appropriate operations performed, the security/diagnostics unit 14 remains in the higher-power mode for a predetermined timeout period, as shown at step 1008. If during this timeout period no other command is received via the wireless interface 28, the security/diagnostics unit 14 returns back to the low-power mode.

The wireless technical support service can thus be convenient and efficient from the perspectives of both the user 10 and the service provider that can potentially avoid unnecessary and costly displacements to get a technician physically repairing, troubleshooting or otherwise modifying the laptop computer 12. Indeed, based on the messages 500, 520 exchanged between the server 60 and the security/diagnostics unit 14 via the wireless network 24, the technician 90 may be able to remotely perform various required technical support operations on the laptop computer 12, including possibly identifying the cause of a problem affecting the laptop computer 12 and remotely correcting this problem (e.g., by wirelessly modifying a configuration setting of the laptop computer 12 or uploading an application into the memory system 42 of the laptop computer 12). In cases where the technician 90 determines based on the messages 500, 520 exchanged between the server 60 and the security/diagnostics unit 14 that a physical modification of the laptop computer 12 needs to be effected (e.g., one or more hardware components need to be changed), the information derived from this exchange of messages can pinpoint the required physical modification and allow a technician to make an on-site visit, or the user 10 to come to a service point, with materials (e.g., a replacement for the one or more defective hardware components) already prepared to rapidly effect the required modification.

It will be appreciated that, in other embodiments, various other interactions may take place between the security/technical support entity 20 and the security/diagnostics unit 14 of the laptop computer 12 as part of the wireless technical support service.

For example, in this embodiment, the security/diagnostics unit 14 implements a plurality of levels of access control which determine a degree of control over the laptop computer 12 that is granted to the technician 90. In one specific example of implementation, the access control is implemented by determining which commands, among those received by the wireless interface 28, the laptop computer 12 is allowed to execute. The actual access control and the selection of the level of access control is implemented by software that is stored in the storage medium 57 of the processing element 63 and executed by the processor 74 of the processing element 63.

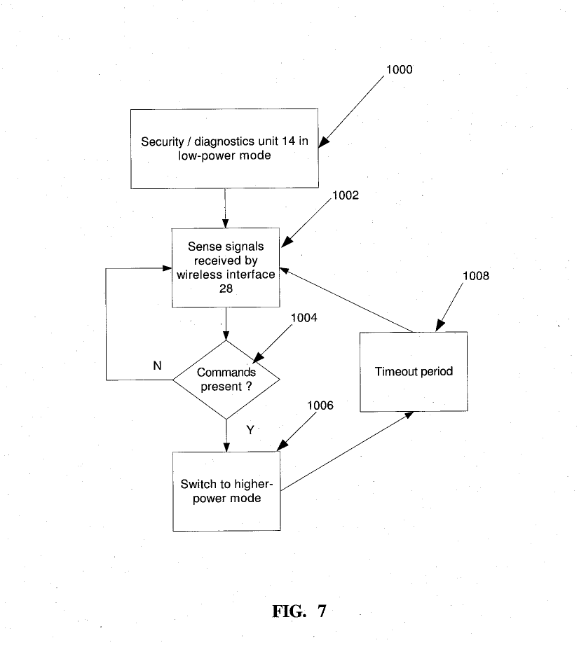

FIG. 8 shows a flowchart illustrating an example of a process for performing the selection of the level of access control that the security/diagnostics unit 14 is to implement. In this example, the process starts at step 1100 and, at step 1102, the software executing in the processing element 63 reads a user operable selector to determine the selected level of access control among a plurality of possible levels of access control. At step 1104, the process implements the selected level of access control. These steps will now be discussed in greater detail.

The user operable selector includes at least one key on the laptop computer 12 or on a peripheral that communicates with the laptop computer 12 allowing the user 10 to change the access control setting. A given key of the at least one key can be a dedicated key that has a single function which is to set the desired level of access control. Alternatively, a given key of the at least one key can be a shared key which, in contrast to a dedicated key, also has some other function in addition to the level of access control setting. Examples of keys that can be employed to implement the user operable selector include:

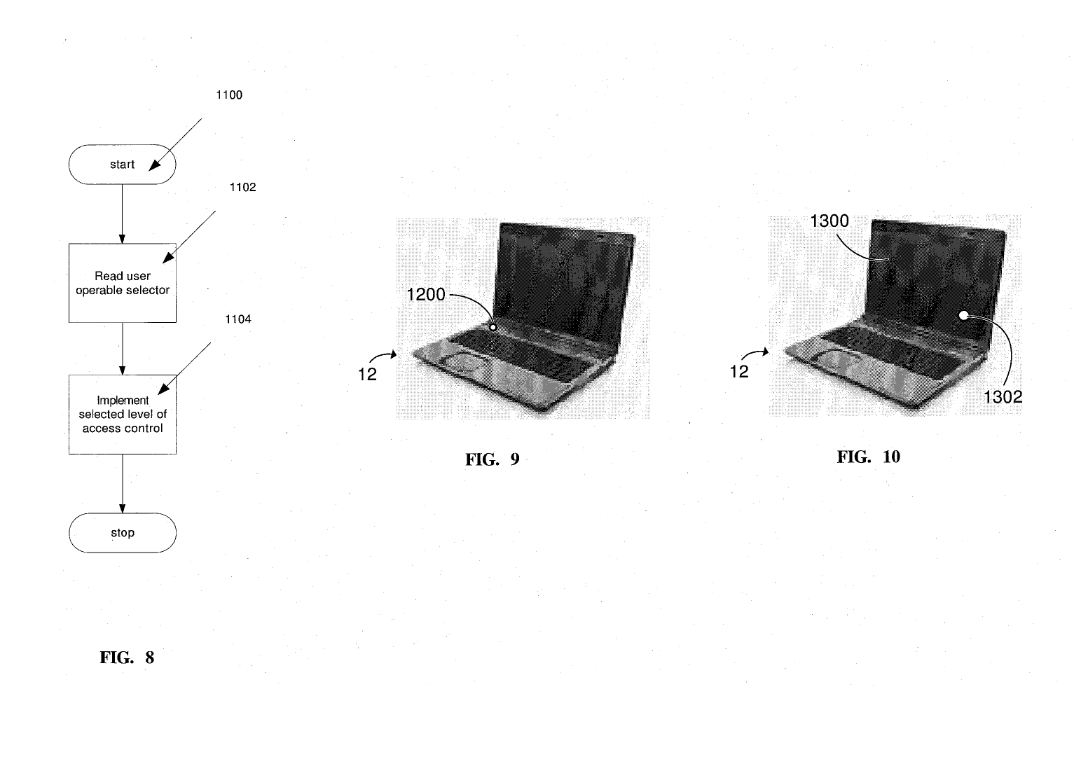

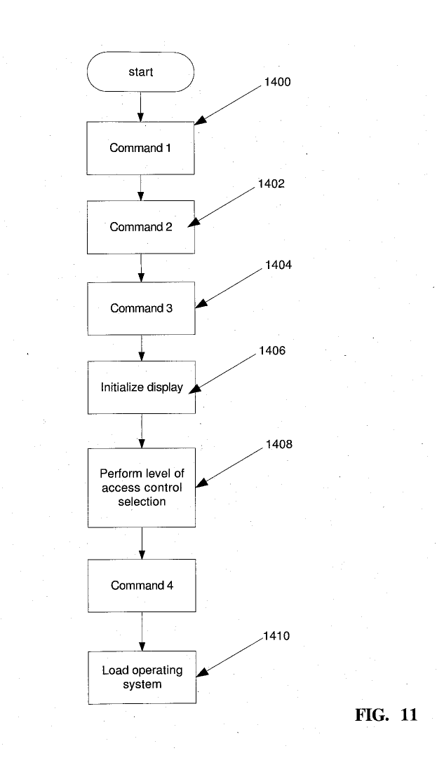

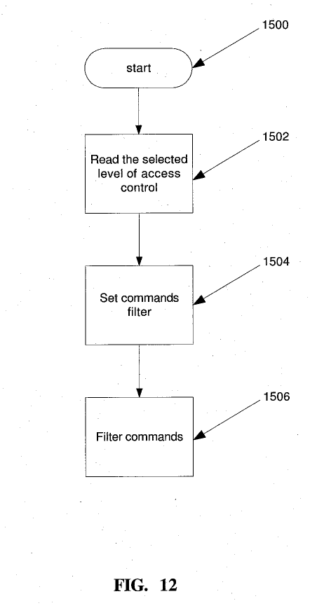

1. One or more dedicated keys accessible to the user 10 of the laptop computer 12.
In one embodiment, as shown in FIG. 9, the security/diagnostics unit 14 is provided with a key 1200 that can be operated by the user 10. The key 1200 can be a mechanical button that has a number of possible states, where each state corresponds to a certain level of access control. In one possible example, the button has two states, where a first state corresponds to a first level of access control and a second state corresponds to a second level of access control. The key 1200 is directly wired to the control unit 30 of the security/diagnostics unit 14. This wiring can be done in any suitable way in various embodiments. The processing element 63 of the security/diagnostics unit 14 determines the state of the key 1200 and implements the level of access control accordingly.
For instance, in one possible scenario, the first level of access control rejects any commands sent by the technician 90. Accordingly, the technician 90 has no control over the laptop computer 12. The second level of access control enables the laptop computer 12 to execute one or more commands. An example of a command that the laptop computer 12 would be allowed to execute is to start the laptop computer 12 when the laptop computer 12 is powered off. Another command that can also be allowed could be a selection of a mode in which the operating system 53 will be loaded, such as normal loading or safe loading where only a limited number of drivers are loaded to facilitate diagnosis.
It should be appreciated that the key 1200 can have more than two settings and can have three or more possible settings allowing selecting among more than two possible levels of access control. It should also be appreciated that multiple keys such as the key 1200 may be provided to enable selections among multiple levels of access control.
Since the key 1200 is directly connected to the control unit 30 of the security/diagnostics unit 14, it is, therefore, functionally independent from the main processing unit 35 of the laptop computer 12. Accordingly, the selection of the level of access control can be made while the laptop computer 12 is in different operative states. Specifically, the selection of the level of access control can be made when the laptop computer 12 is shut down, when the laptop computer 12 is performing a boot operation or when the operating system 53 has partly or completely loaded.
Another option is depicted in FIG. 10. In this embodiment, the laptop computer 12 comprises a touch sensitive screen 1300. The screen 1300 displays an area 1302 that is responsive to touch, either directly with the hand or via a stylus, to perform the level of access control selection. The area 1302 constitutes a virtual manually operable key. In a possible variant, multiple virtual manually operable keys can be displayed on the screen 1300, providing more than two access control options.
In the embodiment of FIG. 10, the security/diagnostics unit 14 is dependent on hardware of the laptop computer 12 to receive input from the user 10. Specifically, the security/diagnostics unit 14 needs the display 38 to operate in order to show the virtual manually operable key(s) to the user 10 and to read the area(s) 1302 “touched” by the user 10 in order to derive which key was actuated. Accordingly, the display 38 should be initialized and powered in order to provide those services to the security/diagnostics unit 14.
If it is desired to be able to make the level of access control selection when the laptop computer 12 is shut down, arrangements should therefore be provided in order to initialize and power the display 38. This may be done directly by the security/diagnostics unit 14. In such cases, the security/diagnostics unit 14 may be provided with a minimal display driver and may have connections to the computer hardware such as to communicate with the display 38 in order to power it, initialize it, send data to it such as to display the virtual keys and then read the “touch” information generated by the user 10. The security/diagnostics unit 14 is provided with a video driver and “touch” capture driver at the level of the interface with the laptop computer 12 and which allow the security/diagnostics unit 14 to interact with the display 38 when the laptop computer 12 is powered off.
Another possible approach is to allow the level of access control selection when the laptop computer 12 is booting and the display 38 is initialized as part of the booting process. In this variant, the security/diagnostics unit 14 may not perform a level of access control selection when the laptop computer 12 is powered off. Rather, the level of access control selection is enabled during the booting sequence. FIG. 11 shows a flowchart that illustrates this in greater detail.
The flowchart shown in FIG. 11 illustrates a series of steps that occur when the laptop computer 12 is powered up under this variant. The process includes the execution of a number of commands 1400, 1402, 1404 which typically would be part of the boot sequence. Examples of commands include a power-on self-test and initialization of drivers and hardware. One of those commands is the loading of a driver 1406 that initializes the display 38. In the case of touch sensitive displays, the driver would include, in addition to the driver to display images, a driver that captures the “touch” information on the screen and communicates it back to a resource that can use it, such as the security/diagnostics unit 14.
Once the display 38 has been initialized, the level of access control selection can be performed, as shown at step 1408. This can be done as described earlier, which is to display on the screen 1300 one or more virtual keys and change the level of access control in the security/diagnostics unit 14 according to the actual key operated by the user 10.
Upon completion of step 1408, execution of the boot sequence can continue leading to the loading of the operating system 53 in memory at step 1410.
Accordingly, in the example provided above, interaction with the user 10 is implemented via program code executed as part of the boot sequence. This program code may reside with the remainder of the boot instructions 51, in this case, in the storage device that holds the BIOS 43 or may reside in the storage medium 57 of the processing element 63 of the security/diagnostics unit 14.
   2. One or more shared keys accessible to the user 10 of the laptop computer 12.
In the case of shared keys, a single key or a combination of keys that have other functions than the selection of the level of access control can be used to perform a level of access control selection. One example is to use a combination of mechanical keys on the keyboard 41 (e.g., “Ctrl”+“Alt”+“A”), or virtual keys on the display 38, where each combination indicates a different level of access control. Another possibility is to use a fingerprint reader (not shown) where, the user 10 is required to swipe a finger over the reader such as to enable a switch to a level of access control where the laptop computer 12 is enabled to execute commands such as a command to power up the laptop computer 12.
The implementation of these examples can be done generally as discussed above. The security/diagnostics unit 14 can be provided with hardware and/or software to initialize the hardware it relies upon to interface with the user 10 independently of the laptop computer 12, or rely on the laptop computer 12 to initialize those hardware devices and then perform the level of access control selection.

In some embodiments, the security/diagnostics unit 14 is provided with a visual indicator that can assist the user 10 in performing the level of access control selection. The indicator can be used to send prompts to the user 10 and thus guide the user 10 in performing the desired level of access control selection in addition to indicating or confirming the level of access control that has been selected.

The visual indicator can be shown on the display 38 of the laptop computer 12. When virtual keys are used to effect the level of access control selection, the virtual keys themselves may constitute the indicator as the user 10 can see the available options and also which option has been selected. As an aid to the selection, each option can be provided with an explanation, showing on the display 38, to provide additional details as to what the option entails. For instance, the explanation can tell the specifics of a level of access control, such as what the technician 90 is allowed and not allowed to do to the laptop computer 12 under that level of access control.

When mechanical keys are used to effect the level of access control selection, the visual indicator on the display 38 can include a prompt to direct the user 10 as to the keys that need to be operated, provide a list of the available level of access control options and what the current level of access control is. Alternatively, the visual indicator can be provided separately from the display 38. In such cases, the visual indicator can be a separate display driven by the security/diagnostics unit 14. In a simple form of implementation, this display can be an indicator lamp that shows via an on/off state the level of access control option. An “on” lamp state corresponds to a level of access control where at least some commands can be executed by the laptop computer 12, while an “off” lamp state corresponds to a level of access control where no commands would be executed.

Various modifications to the above-considered embodiments can be envisaged. For example, in some embodiments, the user operable selector may include a single dedicated mechanical key or a combination of shared mechanical keys (e.g., “Ctrl”+“Alt”+“A”) that can be acted on by the user 10 to cause the control unit 30 of the security/diagnostics unit 14 to bring up on the display 38 a graphical user interface (GUI) allowing the user 10 to select the desired level of access control (hereinafter referred to as the “access control GUI”). The access control GUI may present a current level of access control and a number of options selectable by the user 10 that define a plurality of possible levels of access control to be provided to the technician 90. Each option can be provided with an explanation providing details as to what the option entails (e.g., what the technician 90 is allowed and not allowed to do to the laptop computer 12 under that level of access control).

The access control GUI may be protected by a password that needs to be entered by the user 10 in order to be able to view and enter information via the access control GUI. For instance, upon detecting that the user 10 acted on the single dedicated mechanical key or combination of shared mechanical keys, the control unit 30 may cause the display 38 to present a window prompting the user 10 to enter the password. The password, which may have been established (e.g., selected by) the user 10 during a registration phase for the wireless technical support service (an example of which is provided later on) and stored in the storage medium 57 of the control unit 30, may be entered by the user 10. Upon determining that the password entered by user 10 matches that stored in the storage medium 57, the control unit 30 proceeds to allow the user 10 to access and use the access control GUI displayed on the display 38 in order to select a desired level of access control to be implemented.

A default level of access control can be set in the control unit 30 of the security/diagnostics unit 14. For example, in some embodiments, the default level of access control may be a “maximum” level of access control in which any command sent by the technician 90 (including commands to power on the laptop computer 12) is executed by the control unit 30. The user 10 can be made aware (e.g., when registering for the wireless technical support service) of the default level of access control and that he/she can change this default setting at any time. In embodiments where the default setting is the aforementioned maximum level of access control, the user 10 can also be made aware that, if he/she changes this setting such that commands to remotely power on the laptop computer 12 will not be executed by the control unit 30, he/she would have to ensure that the laptop computer 12 is powered on before it can be remotely serviced and that remote technical support operations at the level of the BIOS 43 and the operating system 53 of the laptop computer 12 may no longer be possible following this change.

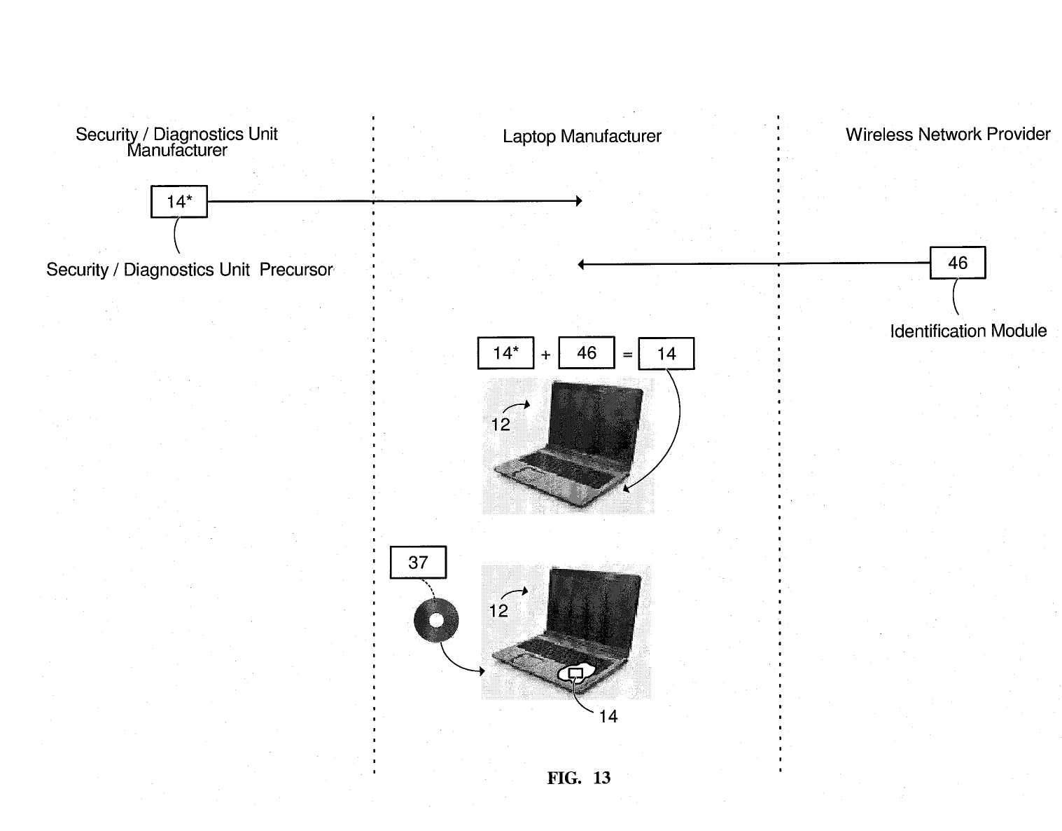

FIG. 12 illustrates an example of operations that can occur under step 1104 which shows the process for implementing the level of access control that has been selected by the user 10. The process starts at step 1500, where it is assumed that the wireless interface 28 is operating and receiving commands sent from the security/technical support entity 20 at its remote location. At step 1502, the selected level of access control is read. The selected level of access control can be stored in any suitable storage device, such as in the storage medium 57 of the processing element 63 of the security/diagnostics unit 14. This can be in the form of a flag or any other suitable representation that is changed each time a new selection is made. The memory location holding the selected level of access control is non-volatile to prevent loss of the information in case power to the security/diagnostics unit 14 is lost.

At step 1504, the security/diagnostics unit 14 implements a filter for filtering the commands received at the wireless interface 28. The filter is set according to the selected level of access control, where each filter setting corresponds to a level of access control. For example, the selected level of access control may define a set of filter settings whereby any diagnostic and/or maintenance commands (including commands to power on the laptop computer 12) received at the wireless interface 28 are allowed to be executed by the control unit 30. As another example, the selected level of access control may define a set of filter settings whereby diagnostic and/or maintenance commands received at the wireless interface 28 which involve access to one or more specific folders (e.g., “My Documents”) stored in the memory system 42 of the laptop computer 12 are not allowed to be executed by the control unit 30. As yet another example, the selected level of access control may define a set of filter settings whereby only diagnostic and/or maintenance commands received at the wireless interface 28 which pertain to diagnosis and correction of hardware-related issues are allowed to be executed by the control unit 30. As yet another example, the selected level of access control may define a set of filter settings whereby maintenance commands (e.g., software upgrade commands) received at the wireless interface 28 are allowed to be executed by the control unit 30, while no diagnostic commands received at the wireless interface 28 are allowed to be executed by the control unit 30.

At step 1506, the control unit 30 of the security/diagnostics unit 14 filters the commands received at the wireless interface 28 to determine which, if any, are to be executed, in accordance with the level of access control selected by the user 10. Upon making this determination, the control unit 30 may proceed to perform one or more diagnostic and/or maintenance operations on the laptop computer 12 in accordance with one or more of the received commands that are allowed to be executed.

Provision of Laptop Computer with Security/Diagnostics Unit

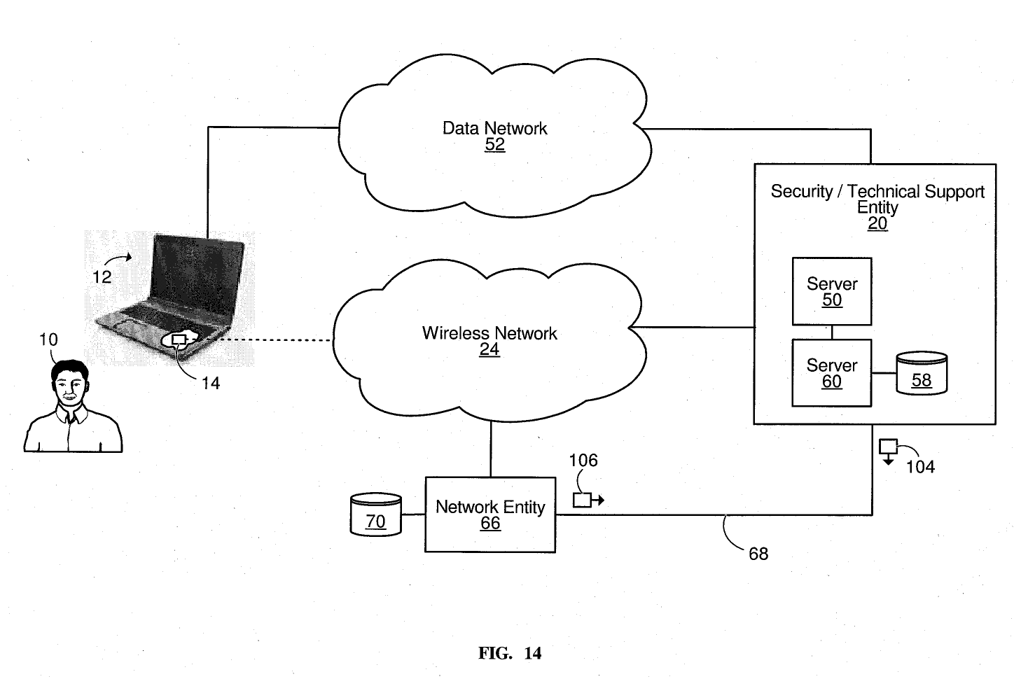

Referring to FIG. 13, there is shown an example process by which the laptop computer 12 may be provided with the security/diagnostics unit 14. For purposes of this example, it is assumed that, in this embodiment, the nature of the wireless network 24 is such that the security/diagnostics unit 14 comprises the aforementioned identification unit 46 allowing it to have access to and communicate over the wireless network 24.

In this example, a laptop manufacturer manufacturing the laptop computer 12 obtains a security/diagnostics unit 14* that is a precursor to the security/diagnostics unit 14. The security/diagnostics unit 14* essentially comprises the aforementioned functional components of the security/diagnostics unit 14, but lacks the identification unit 46 which is obtained separately, as discussed below.

In this embodiment, the laptop manufacturer obtains the security/diagnostics unit 14* by receiving it from a third-party manufacturer that is distinct from the laptop manufacturer. For example, the third-party manufacturer may, upon receiving an order from the laptop manufacturer or from the service provider providing the wireless security service and/or the wireless technical, ship to the laptop manufacturer security/diagnostics units (including the security/diagnostics unit 14*) for integration into laptop computers (including the laptop computer 12) manufactured by the laptop manufacturer. In other embodiments, the laptop manufacturer may obtain the security/diagnostics unit 14* by manufacturing it entirely itself or by manufacturing some of its components itself and receiving other ones of its components from the third-party manufacturer.

Also, in this example, the laptop manufacturer obtains the identification unit 46. More particularly, the laptop manufacturer obtains the identification unit 46 by receiving it from the wireless network provider. For example, the wireless network provider may, upon receiving an order from the laptop manufacturer or from the service provider providing the wireless security service and/or the wireless technical support service, ship to the laptop manufacturer identification unit (including the identification unit 46) for integration into laptop computers (including the laptop computer 12) manufactured by the laptop manufacturer. When providing the identification unit 46 to the laptop manufacturer, the wireless network provider also provides to the laptop manufacturer identification information corresponding to the identification information stored in the identification unit 46 (e.g., an IMSI). This identification information is intended to be supplied to, and used by, an end-user (such as the user 10) during a registration phase of the wireless security service and/or the wireless technical support service, as further discussed below. For example, the identification information may be provided as part of a sticker to be stuck on the casing of the laptop computer 12 or on a printed document to be supplied with the laptop computer 12 when purchased.

Upon obtaining the security/diagnostics unit 14* and the identification unit 46, the laptop manufacturer installs the identification unit 46 in the security/diagnostics unit 14* and integrates this resulting component into the laptop computer 12, thus providing the laptop computer 12 with the security/diagnostics unit 14. The laptop manufacturer also ensures that the identification information received with the identification unit 46 will be provided to an end-user (such as the user 10) of the laptop computer 12.

It is recalled that, in this embodiment, the control unit 30 of the security/diagnostics unit 14 has access to the power management controller 76 of the laptop computer 12 via the system management bus 78 of the laptop computer 12. Thus, as it integrates components to provide the laptop computer 12 with the security/diagnostics unit 14, the laptop manufacturer proceeds to install (e.g., insert and affix) components of the security/diagnostics unit 14 such that the interface 61 of the control unit 30 enables the control unit 30 to have access to the power management controller 76 via the system management bus 78, which are provided on a main circuit board of the laptop computer 12 while it is manufactured.

In some cases, the laptop manufacturer may then load software 37 (which may include firmware) into the control unit 30 of the security/diagnostics unit 14 in order to implement that controller's functionality. The software 37 may be provided to the laptop manufacturer by the service provider providing the wireless security service and/or the wireless technical support service and is loaded via an interface component of the laptop computer 12. For example, in some embodiments, the software may be stored on a computer-readable medium, such as an optical disc (e.g., a CD or DVD) or a USB flash drive, provided by the service provider to the laptop manufacturer. In this case, the software 37 may be loaded into the security/diagnostics unit 14 by reading the computer-readable medium via a suitable interface component, such as an optical disc drive or a USB port, of the laptop computer 12. In another embodiment, the software may be downloaded from a server operated by the service provider and connected to a data network (e.g., the Internet) to which is connected the laptop computer 12. In this case, the software may be loaded into the security/diagnostics unit 14 by downloading it from the server via a data network interface (e.g., an Ethernet port) of the laptop computer 12.

Upon being loaded into the security/diagnostics unit 14, the software 37 prevents access to the security/diagnostics unit 14 via interface components (e.g., an optical disc drive, USB port or data network interface) of the laptop computer 12. In other words, altering, disabling or otherwise tampering with functionality of the control unit 30 of the security/diagnostics unit 14 is prevented. However, as discussed later on, during an activation phase of the wireless security service and/or the wireless technical support service, a temporary path to the security/diagnostics unit 14 is established by the laptop computer 12 in order to cause the security/diagnostics unit 14 to transmit a message via the wireless network 24 to activate the wireless security service and/or the wireless technical support service.

It will be appreciated that, in some embodiments, the software 37 may be pre-loaded in the security/diagnostics unit 14* obtained by the laptop manufacturer in which case there may be no need for the laptop manufacturer to load any software into the security/diagnostics unit 14.

Although an example process has been described, it is to be understood that, in other embodiments, the laptop computer 12 may be provided with the security/diagnostics unit 14 using various other processes.

Registration for and Activation of Wireless Security Service and/or Wireless Technical Support Service

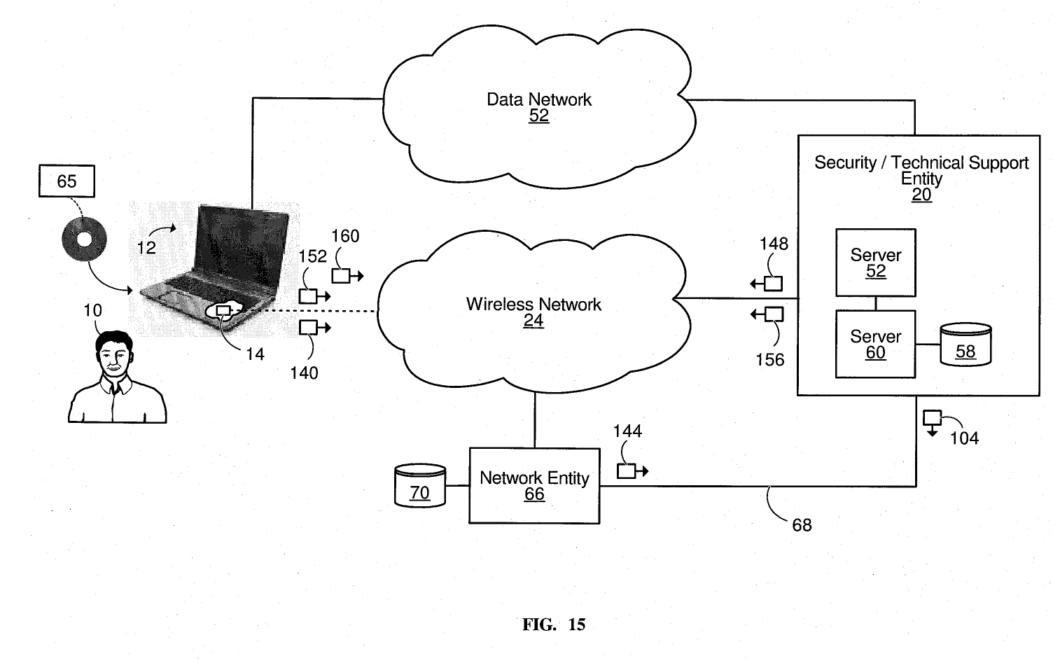

With reference to FIG. 14, there is shown an example process by which the user 10 may register for and activate the wireless security service and/or the wireless technical support service contemplated herein. For purposes of this example, it is assumed that the user 10 purchased the laptop computer 12 and desires to avail himself/herself of both of these services, and that the service provider operating the security/technical support entity 20 provides both of these services. It will be appreciated that, in other examples, the user 10 may wish to subscribe to only one of these services and/or different service providers may provide different ones of these services.

Thus, as part of a registration phase, in this example, the user 10 interacts with the service provider in order to register for both the wireless security service and the wireless technical support service. To facilitate this registration phase, in this embodiment, the security/technical support entity 20 includes a server 50 that is connected to a data network 52 (e.g., the Internet) and that implements a network site (e.g., a website) accessible via the data network 52. The server 50 comprises suitable hardware and/or software for implementing a plurality of functional components, including an interface and a processing entity. The interface of the server 50 is adapted to receive and send data in the form of messages from and to computers connected to the data network 52 as well as other elements (e.g., computers or databases) communicatively coupled to that server but not necessarily connected to the data network 52. The processing entity of the server 50 is adapted to effect various processing operations to implement that server's functionality.

For purposes of this example, it is assumed that the user 10 uses the laptop computer 12 to interact with the network site implemented by the server 50 in order to register for the wireless security service and the wireless technical support service. To that end, it is assumed that the laptop computer 12 is connected to the data network 52 and is operative to run a software application implementing a network browser (e.g., a web browser) with which the user 10 can interact via a user interface of the laptop computer 12 in order to access and interact with network sites of the data network 52. In other examples, the user 10 may use another computer connected to the data network 52 to interact with the network site implemented by the server 50 in order to register for the wireless security service and the wireless technical support service.

Interaction of the user 10 with the network site implemented by the server 50 involves the network browser implemented by the laptop computer 12 interacting with the server 50 in order to allow the user 10 to view, hear or otherwise be exposed to content (e.g., web pages) of the network site via the display 38 and/or one or more other output devices of the laptop computer 12, and possibly to input information (e.g., entering text, selecting an option, clicking on a graphical button or a hyperlink) via the keyboard 41, the pointing device 44 and possibly one or more other input devices of the laptop computer 12.

Thus, upon accessing the network site implemented by the server 50, the user 10 proceeds to enter a registration section of the network site. This may involve the user 10 login into the registration section, for instance, by inputting a username and password (which may be created as part of an original login attempt).

The network site implemented by the server 50 prompts the user 10 to enter registration information. For example, this registration information may include personal information regarding the user 10 (e.g., a name, date of birth, etc.), contact information regarding the user 10 (e.g., a telephone number, civic address, email address, etc.), billing information (e.g., credit card information), laptop computer information regarding the laptop computer 12 (e.g., its serial number, model, manufacturer's name). The registration information may also include a password (which may be different or identical to the aforementioned password which may be needed to login) selected by the user 10 and which can be used to authenticate the user 10 for purposes of the wireless security service and the wireless technical support service (including, in some cases, to gain access to the aforementioned access control GUI). Also, in this embodiment, the network site implemented by the server 50 prompts the user 10 to enter the aforementioned identification information (e.g., an IMSI) provided by the laptop manufacturer and corresponding to the identification information stored in the identification unit 46 of the security/diagnostics unit 14 of the laptop computer 12. The information entered by the user 10 is captured by the server 50 and passed to the aforementioned server 60.

Based on the information entered by the user 10 and captured by the server 50, the server 60 creates a record associated with the user 10 and including the entered information. The record associated with the user 10 is stored in the aforementioned database 58 accessible to the server 60 and containing records associated with subscribers to the wireless security service and the wireless technical support service. The record associated with the user 10 includes a subscriber identifier (e.g., an account number, a name) to identify the user's account.

The server 60 proceeds to cause transmission of a message 104 to a network entity 66 operated by the wireless network provider, via a communication link 68. The communication link 68 may be established over a network, which may comprise part of the data network 52, a public telephony network and/or another network. Alternatively, the communication link 68 may be a dedicated and secure link established between the server 60 and the network entity 66. It will be recognized that the communication link 68 may be implemented in various manners in different embodiments. It will also be recognized that, where the message 104 needs to travel over the data network 52, the server 60 may cause the server 50 to send the message 104.

The message 104 can be viewed as a request to obtain from the wireless network provider “activation information” to be subsequently transmitted by the security/diagnostics unit 14 via the wireless network 24 in order to activate the security/diagnostics unit 14. The security/diagnostics unit 14 is said to be “active” when it is granted access to the wireless network 24 by the wireless network provider such that the security/diagnostics unit 14 is capable of communicating with the security/technical support entity 20 via the wireless network 24. Conversely, the security/diagnostics unit 14 is said to be “inactive” when it is not granted access to the wireless network 24 by the wireless network provider such that the security/diagnostics unit 14 is incapable of communicating with the security/technical support entity 20 via the wireless network 24.

The activation information can take on many forms in various embodiments. For example, in one embodiment, the activation information may comprise authentication information (e.g., an authentication key) to be transmitted by the security/diagnostics unit 14 via the wireless network 24 in order to authenticate the security/diagnostics unit 14. When authenticated, the security/diagnostics unit 14 becomes active, i.e., it is granted access to the wireless network 24 to allow exchange of messages between itself and the security/technical support entity 20 via the wireless network 24.

In order to obtain the activation information, the message 104 conveys the identification information entered by the user 10 and corresponding to the identification information stored in the identification unit 46 of the security/diagnostics unit 14.

Upon receiving the message 104, the network entity 66 processes it and proceeds to obtain the activation information. In one embodiment, the wireless network provider may have previously generated the activation information and stored it in a database 70 in association with identification information corresponding to the identification information stored in the identification unit 46 of the security/diagnostics unit 14. The network entity 66 may then obtain the activation information by consulting the database 70 on a basis of the identification information stored in the security/diagnostics unit 14 and conveyed by the message 104, and retrieving from the database 70 the activation information that is associated with that identification information. In another embodiment, the network entity 66 may obtain the activation information by generating it in response to receiving the message 104. The network entity 66 may then store the generated activation information in the database 70 in association with identification information corresponding to the identification information stored in the identification unit 46 of the security/diagnostics unit 14.

Having obtained the activation information, the network entity 66 proceeds to send a message 106 conveying the activation information to the server 60 via the communication link 68.

Upon receiving the message 106, the server 60 processes it to obtain the activation information. The server 60 proceeds to pass to the server 50 the activation information and the account identifier that is included in the record associated with the user 10 in the database 58.

The network site implemented by the server 50 communicates to the user 10 the activation information and the account identifier. For example, the activation information and the account identifier may be displayed on the display of the laptop computer 12 for the user 10 to see. The network site instructs the user 10 to take note of (e.g., write down) the activation information and the account identifier for later use during an activation phase of the wireless security service and the wireless technical support service.

Upon completion of the registration phase, the network site implemented by the server 50 informs the user 10 that registration is completed and instructs the user 10 to proceed to the activation phase of the wireless security service and the wireless technical support service.

Although in this example the user 10 interacts with the network site implemented by the server 50 provided by the service provider in order to register for the wireless security service and the wireless technical support service, it will be appreciated that this registration phase may be effected in other manners. For example, the user 10 may contact a customer service representative of the service provider in order to register for the wireless security service and the wireless technical support service.

With additional reference to FIG. 15, the user 10 proceeds with the activation phase of the wireless security service and the wireless technical support service. An objective of the activation phase is to activate the security/diagnostics unit 14, i.e., cause the security/diagnostics unit 14 to be granted access to the wireless network 24 by the wireless network provider such that the security/diagnostics unit 14 can communicate with the security/technical support entity 20 via the wireless network 24. To that end, the laptop computer 12 is commanded (i.e., instructed) to cause the security/diagnostics unit 14 to transmit over the wireless network 24 the activation information obtained during the registration phase.

In this embodiment, a program element 65 is executed by the laptop computer 12 to cause the security/diagnostics unit 14 to transmit the activation information over the wireless network 24.

More particularly, in this embodiment, a computer-readable medium, such as an optical disc or a USB flash drive, storing the program element 65 may be provided to the user 10. The computer-readable medium may be provided to the user 10 when the user 10 purchases the laptop computer 12 or following registration of the user 10 via the network site implemented by the server 50. The user 10 may then allow the laptop computer 12 to read the computer-readable medium via an interface component, such as an optical disc drive or a USB port, of the laptop computer 12 in order to cause execution of the program element 65.

In other embodiments, the program element 65 may be downloaded from a server (which may be the server 50 or another server) operated by the service provider and connected to a data network (e.g., the Internet) to which is connected the laptop computer 12. In this case, the program element 65 may be downloaded from the server via a data network interface (e.g., an Ethernet port) of the laptop computer 12. In yet other embodiments, the program element 65 may have been loaded by the laptop manufacturer during manufacturing of the laptop computer 12.

The user 10 interacts with the user interface of the laptop computer 12 to cause the program element 65 to be executed. Execution of the program element 65 by the laptop computer 12 causes the laptop computer 12 to prompt the user 10 to input the activation information obtained during the registration phase. For example, the program element 65 may cause the display of the laptop computer 12 to display a window prompting the user 10 to enter the activation information. The user 10 proceeds to interact with the user interface of the laptop computer 12 in order to enter the activation information.

Once the activation information is entered, the program element 65 causes the security/diagnostics unit 14 to send a message 140 to the network entity 66 via the wireless network 24. The message 140 can be viewed as a request to activate the security/diagnostics unit 14, i.e., a request to grant the security/diagnostics unit 14 access to the wireless network 24 in order to allow the security/diagnostics unit 14 to communicate with the security/technical support entity 20 via the wireless network 24. To that end, the message 140 conveys (1) the identification information stored in the identification unit 46 and (2) the activation information entered by the user 10. In some cases, the message 140 may be routed to the network entity 66 based on an identifier of the wireless network provider (e.g., a mobile network code (MNC)) included in the identification information.

Upon receiving the message 140, the network entity 66 processes it and determines that it is a request to activate the security/diagnostics unit 14. The network entity 66 proceeds to consult the database 70 on a basis of the identification information conveyed by the message 140 to find a particular record contained in the database 70 and corresponding to this identification information. Upon finding the particular record, the network entity 66 obtains the activation information included in the particular record.

The network entity 66 proceeds to compare the activation information conveyed by the message 140 to the activation information obtained from the particular record contained in the database 70 and corresponding to the identification information conveyed by the message 140.

If the activation information conveyed by the message 140 does not correspond to the activation information obtained from the particular record, the network entity 66 denies the security/diagnostics unit 14 access to the wireless network 24. The network entity 66 may also send a message (not shown) via the wireless network 24 to the security/diagnostics unit 14. Upon reception of this message by the security/diagnostics unit 14, the program element 65 may cause the display of the laptop computer 12 to display a notice informing the user 10 that access to the wireless network 24 could not be granted, and thus activation of the wireless security service and the wireless technical support service could not be effected, based on the activation information provided by the user 10.

For purposes of this example, assume that the activation information conveyed by the message 140 corresponds to the activation information obtained from the particular record contained in the database 70 and corresponding to the identification information conveyed by the message 140. In this case, the network entity 66 activates the security/diagnostics unit 14, i.e., the network entity 66 grants the security/diagnostics unit 14 access to the wireless network 24 to enable the security/diagnostics unit 14 to exchange messages with the security/technical support entity 20 via the wireless network 24.

The network entity 66 proceeds to send a message 144 to the server 60 via the communication link 68. The message 144 conveys the identification information stored in the identification unit 46 of the security/diagnostics unit 14 (and conveyed by the message 140) and indicates that the security/diagnostics unit 14 has been granted access to the wireless network 24 (i.e., has been activated).

Upon receiving the message 144, the server 60 processes it to learn that the security/diagnostics unit 14 has been granted access to the wireless network 24. Based on the identification information conveyed by the message 144, the server 60 consults the database 58 to find the record associated with the user 10 and including identification information corresponding to the identification information conveyed by the message 144.

The server 60 proceeds to transmit a message 148 to the security/diagnostics unit 14 via the wireless network 24. It is assumed that, prior to transmission of the message 148, the security/diagnostics unit 14 is in sleep mode. The message 148 conveys a command to put the security/diagnostics unit 14 in wake mode.

In response to receiving the message 148, the security/diagnostics unit 14 puts itself in wake mode. The security/diagnostics unit 14 also sends a message 152 to the server 60 via the wireless network 24 to acknowledge receipt of the message 148 and confirm that it is in wake mode.

Upon receiving the message 152, the server 60 determines that the security/diagnostics unit 14 has received the message 148 and placed itself in wake mode. The server 60 proceeds to transmit a message 156 to the security/diagnostics unit 14 via the wireless network 24. The message 156 conveys a command to put the security/diagnostics unit 14 in sleep mode.

In response to receiving the message 156, the security/diagnostics unit 14 puts itself back in sleep mode. The security/diagnostics unit 14 also sends a message 160 to the server 60 via the wireless network 24 to acknowledge receipt of the message 156 and confirm that it is in sleep mode.

Upon receiving the message 160, the server 60 determines that the security/diagnostics unit 14 has received the message 156 and placed itself in sleep mode. The server 60 concludes that the security/diagnostics unit 14 is operating correctly and that the wireless security service and the wireless technical support service have been activated.

The server 60 proceeds to update the record in the database 58 associated with the user 10 to indicate that the wireless security service and the wireless technical support service have been activated. The server 60 may then cause an electronic message (e.g., an electronic mail (email) message) to be sent to the user 10 to confirm activation of the wireless security service and the wireless technical support service.

It will thus be appreciated that registration for and activation of the wireless security service and the wireless technical support service is made efficient, convenient and secure for the user 10, the wireless network provider and the service provider providing these services.

It will also be appreciated that registration for and activation of the wireless security service and/or the wireless technical support service can be effected in other manners in other embodiments. For example, in some embodiments, rather than being effected via the network site implemented by the server 50 of the security/technical support entity 20, the user 10 may register for the wireless security service and/or the wireless technical support service by interacting with a customer service representative of the service provider.

It is recalled that, in this embodiment, the service provider providing the wireless security service and/or the wireless technical support service is distinct from the wireless network provider that provides the wireless network 24. In some cases, in addition to providing a wireless telephony service, the wireless network provider may provide a wireless data network access service (e.g., a wireless Internet access service) via the wireless network 24. As part of a business relationship between the service provider and the wireless network provider, the service provider may invite subscribers of the wireless security service and/or the wireless technical support service (such as the user 10) to subscribe to the wireless data network access service provided by the wireless network provider.

For example, when registering for the wireless security service and/or the wireless technical support service on the network site implemented by the server 50, the user 10 may be presented with an offer to subscribe to the wireless data network access service provided by the wireless network provider. This may be effected by the network site implemented by the server 50 providing a link (e.g., a hyperlink) to a network site implemented by a server operated by the wireless network provider. Upon accessing the network site implemented by the server operated by the wireless network provider, the user 10 may proceed to register for the wireless data network access service provided by the wireless network provider.

Accordingly, by allowing the service provider to use the wireless network 24 to provide the wireless security service and/or the wireless technical support service, the wireless network provider benefits from increased exposure which can lead to further subscriptions to its wireless data network access service.

In embodiments considered above, the security/diagnostics unit 14 is designed to allow provision of both the wireless security service and the wireless technical support service contemplated herein. In other embodiments, the laptop computer 12 may comprise a security unit 14A similar to the security/diagnostics unit 14 described above but designed for purposes of providing only the wireless security service. In yet other embodiments, the laptop computer 12 may comprise a diagnostics unit 14B similar to the security/diagnostics unit 14 described above but designed for purposes of providing only the wireless technical support service. In such embodiments, one or more components of the security/diagnostics unit 14 described above may be omitted from the security unit 14A or the diagnostics unit 14B. For example, the location unit 32 may be omitted from the diagnostics unit 14B as there may be no relevance to knowing the location of the laptop computer 12 outside of the wireless security service.

While in embodiments considered above the security/diagnostics unit 14 is used to provide the wireless security service and/or the wireless technical support service in connection with the laptop computer 12, in other embodiments, similar security/diagnostics unit may be provided in other types of personal computers (including desktop computers) to allow provision of either or both of these services.

Those skilled in the art will appreciate that, in some embodiments, certain functionality of a given component described herein (e.g., components of the security/diagnostics unit 14, components of the security/technical support entity 20, etc.) may be implemented as pre-programmed hardware or firmware elements (e.g., application specific integrated circuits (ASICs), electrically erasable programmable read-only memories (EEPROMs), etc.) or other related elements. In other embodiments, a given component described herein (e.g., components of the security/diagnostics unit 14, components of the security/technical support entity 20, etc.) may comprise a general-purpose processor having access to a storage medium that is fixed, tangible, and readable by the general-purpose processor and that stores program code for operation of the general-purpose processor to implement functionality of that given component. The storage medium may store data optically (e.g., an optical disk such as a CD-ROM or a DVD), magnetically (e.g., a hard disk drive, a removable diskette), electrically (e.g., semiconductor memory, including ROM such as EPROM, EEPROM and Flash memory, or RAM), or in any another suitable way. Alternatively, the program code may be stored remotely but transmittable to the given component via a modem or other interface device connected to a network over a transmission medium. The transmission medium may be either a tangible medium (e.g., optical or analog communications lines) or a medium implemented using wireless techniques (e.g., RF, microwave, infrared or other wireless transmission schemes).

Although various embodiments of the present invention have been described and illustrated, it will be apparent to those skilled in the art that numerous modifications and variations can be made without departing from the scope of the invention, which is defined in the appended claims.

1-195. (canceled)

196. A personal computer comprising:
a user interface for allowing a user to interact with the personal computer;
a processing unit for executing software, the software comprising a program implementing an operating system; and
a security unit for securing the personal computer when the personal computer is deemed to be missing, the security unit comprising:
a wireless interface to receive, over a wireless network, at least one wireless signal conveying at least one command, the security unit being active when the personal computer is powered on and when the personal computer is powered off such that the wireless interface is able to receive the at least one wireless signal conveying the at least one command whether the personal computer is powered on or powered off; and
a control unit to render the personal computer inoperative in response to the at least one command.

197. A personal computer as claimed in claim 196, wherein, to render the personal computer inoperative, the control unit is configured to:
power off the personal computer if the personal computer is powered on; and
prevent the personal computer from being powered on.

198. A personal computer as claimed in claim 196, the control unit being responsive to the at least one command to cause the wireless interface to transmit, over the wireless network, at least one wireless signal allowing a location of the personal computer to be identified.

199. A personal computer as claimed in claim 198, the at least one wireless signal allowing the location of the personal computer to be identified conveying location information indicative of the location of the personal computer.

200. A personal computer as claimed in claim 199, the location information comprising a set of geo-coordinates.

201. A personal computer as claimed in claim 199, the security unit comprising a location unit to receive wireless location signals and generate the location information based on the wireless location signals.

202. A personal computer as claimed in claim 201, wherein the location unit comprises a global positioning system (GPS) receiver.

203. A personal computer as claimed in claim 196, the security unit being operable in a sleep mode and a wake mode, the security unit consuming less power in the sleep mode than in the wake mode, the at least one command comprising a plurality of commands which comprises a wake command and at least one other command following the wake command, the control unit being responsive to the wake command to cause the security unit to switch from the sleep mode to the wake mode.

204. A personal computer as claimed in claim 203, the control unit comprising a processor for processing the commands, a speed of operation of the processor being faster in the wake mode than in the sleep mode.

205. A personal computer as claimed in claim 203, the wireless network comprising a cellular network, the wake command being conveyed by at least one text message over the cellular network.

206. A personal computer as claimed in claim 205, the at least one text message being at least one short message service (SMS) message.

207. A personal computer as claimed in claim 203, the wake command being conveyed by at least one message having a first format, the at least one other command being conveyed by at least one message having a second format different from the first format.

208. A personal computer as claimed in claim 207, the wireless network comprising a cellular network, the first format being a text messaging format used in the cellular network.

209. A personal computer as claimed in claim 208, the text messaging format being a short message service (SMS) format.

210. A personal computer as claimed in claim 197, comprising a power supply and a power management controller for controlling the power supply, wherein, to power off the personal computer if the personal computer is powered on and to prevent the personal computer from being powered on, the control unit is configured to instruct the power management controller to power off the personal computer if the personal computer is powered on and to prevent the personal computer from being powered on.

211. A personal computer as claimed in claim 210, comprising a system management bus interconnecting the processing unit and the power management controller, the control unit being connected to the power management controller via the system management bus.

212. A personal computer as claimed in claim 211, wherein the system management bus is configured according to the SMBus specification, the PMBus specification, any other I²C-derived bus specification, or any equivalent bus specification.

213. A personal computer as claimed in claim 196, wherein the security unit is operable independently of the operating system.

214. A personal computer as claimed in claim 196, the wireless interface being configured to receive, over the wireless network, at least one other wireless signal conveying at least one other command, the control unit being responsive to the at least one other command to render the personal computer operative.

215. A personal computer as claimed in claim 214, wherein, to render the personal computer operative, the control unit is configured to allow the personal computer to be powered on.

216. A personal computer as claimed in claim 196, comprising a memory system, wherein, to render the personal computer inoperative, the control unit is configured to prevent access to data stored in the memory system.

217. A personal computer as claimed in claim 216, wherein, to prevent access to the data stored in the memory system, the control unit is configured to cause the data stored in the memory system to be erased or encrypted.

218. A personal computer as claimed in claim 196, the program implementing the operating system being a first program, the software comprising a second program implementing a booting operation to initiate loading of the operating system, wherein, to render the personal computer inoperative, the control unit is configured to render the second program corrupted.

219. A personal computer as claimed in claim 196, comprising a power supply for allowing the personal computer to be powered on, the power supply comprising: circuitry to receive power from a power outlet; and a main battery, the security unit comprising a dedicated battery to supply power to the wireless interface and the control unit when the personal computer is powered off.

220. A personal computer as claimed in claim 196, the wireless network comprising a cellular network.

221. A personal computer as claimed in claim 196, the personal computer being a laptop computer.

222. An apparatus for securing a personal computer when the personal computer is deemed to be missing, the personal computer comprising:
a user interface for allowing a user to interact with the personal computer;
a processing unit for executing software, the software comprising a program implementing an operating system; and
a wireless interface to receive and transmit wireless signals over a wireless network,
the apparatus comprising:
an input for receiving at least one command conveyed by at least one wireless signal received at the wireless interface, the input being able to receive the at least one command whether the personal computer is powered on or powered off;
a processing element for processing the at least one command to generate at least one control signal rendering the personal computer inoperative; and
an output for issuing the at least one control signal.

223. A method for securing a personal computer when the personal computer is deemed to be missing, the personal computer comprising:
a user interface for allowing a user to interact with the personal computer;
a processing unit for executing software, the software comprising a program implementing an operating system; and
a wireless interface to receive and transmit wireless signals over a wireless network,
the method comprising:
receiving an indication that the personal computer is deemed to be missing; and
causing transmission of at least one wireless signal to the personal computer over the wireless network, the at least one wireless signal conveying at least one command which, upon being executed at the personal computer, renders the personal computer inoperative, the wireless interface being able to receive the at least one wireless signal conveying the at least one command whether the personal computer is powered on or powered off.

224. A personal computer comprising:
a user interface for allowing a user to interact with the personal computer;
a processing unit for executing software, the software comprising a program implementing an operating system; and
a security unit for securing the personal computer when the personal computer is deemed to be missing, the security unit comprising:
a wireless interface to receive commands over a wireless network; and
a control unit to execute the commands;
the security unit being operable in a sleep mode and a wake mode, wherein:
in the sleep mode, the wireless interface is able to receive a wake command, the wake command, when executed by the control unit, causing the security unit to switch from the sleep mode to the wake mode; and
in the wake mode, the wireless interface is able to receive at least one other command, the at least one other command, when executed by the control unit, causing the security unit to render the personal computer inoperative.

225. A personal computer as claimed in claim 224, the security unit consuming less power in the sleep mode than in the wake mode.

226. A personal computer as claimed in claim 224, the control unit comprising a processor for processing the commands, a speed of operation of the processor being faster in the wake mode than in the sleep mode.

227. A personal computer as claimed in claim 224, the wireless network comprising a cellular network, the wake command being conveyed by at least one text message over the cellular network.

228. A personal computer as claimed in claim 227, the at least one text message being at least one short message service (SMS) message.

229. A personal computer as claimed in claim 224, the wake command being conveyed over the wireless network by at least one message having a first format, the at least one other command being conveyed over the wireless network by at least one message having a second format different from the first format.

230. A personal computer as claimed in claim 229, the wireless network comprising a cellular network, the first format being a text messaging format used in the cellular network.

231. A personal computer as claimed in claim 230, the text messaging format being a short message service (SMS) format.

232. A personal computer as claimed in claim 224, wherein, to render the personal computer inoperative, the security unit is configured to:
power off the personal computer if the personal computer is powered on; and
prevent the personal computer from being powered on.

233. A personal computer as claimed in claim 224, the at least one other command, when executed by the control unit, causing the wireless interface to transmit, over the wireless network, at least one wireless signal allowing a location of the personal computer to be identified.

234. A personal computer as claimed in claim 233, the at least one wireless signal allowing the location of the personal computer to be identified conveying location information indicative of the location of the personal computer.

235. A personal computer as claimed in claim 234, the location information comprising a set of geo-coordinates.

236. A personal computer as claimed in claim 234, the security unit comprising a location unit to receive wireless location signals and generate the location information based on the wireless location signals.

237. A personal computer as claimed in claim 236, wherein the location unit comprises a global positioning system (GPS) receiver.
